(19) United States
(12) Patent Application Publication
(10) Pub. No.: US 2017/0169504 A1
(43) Pub. Date: Jun. 15, 2017

(54) DESCENDING COUNTER VALUE MATCHING WITH INFORMATION SHARING

(71) Applicant: Microsoft Technology Licensing, LLC, Redmond, WA (US)

(72) Inventors: Robert Kleinberg, Watertown, MA (US); Glen Weyl, Boston, MA (US); Bo Waggoner, Cambridge, MA (US)

(21) Appl. No.: 14/967,265

(22) Filed: Dec. 11, 2015

(51) Int. Cl. G06Q 30/08

(52) U.S. Cl. CPC G06Q 30/08

(57) ABSTRACT

A descending price auction may be implemented by one or more computing devices including a counter module configured to generate a series of decreasing counter values, and a matching module configured to match a bidder and an item at least partly in response to a bid received by the computing device. The matching module matches the bidder and the item based at least partly on a particular counter value active when the bidder and item are matched. Additionally, the matching module removes the bidder and the item from the auction based at least partly on the matching.

### BACKGROUND

Auctions can be useful in pairing items with bidders willing to pay a market price for such items. For example, sellers may provide various items for auction, and bidders may enter one or more “bids” for each of the items. In some auctions, the sellers may also enter a suggested price or “ask” associated with each item. However, conventional auctions do not typically provide for an adequate exchange of information between bidders and sellers during the auction. Additionally, conventional auctions are typically organized such that all matches between bidders and items/sellers occur simultaneously, or occur such that relatively low-value matches occur prior to relatively high-value transactions (often called ascending price auctions). An exception is the well-known Dutch Auction in which any bidder may claim the single item for sale at the price on a descending clock. Unlike ascending and simultaneous procedures, however, Dutch auctions have not been extended for the sale together of multiple items. Thus under existing procedures for multiple items, all matches are made simultaneously, in random order or beginning with the lowest value matches, but are never made from the best matches downward.

### SUMMARY

This disclosure describes systems and methods associated with auctions, such as descending price auctions, in which high-value matches between bidders and items/receivers occur prior to relatively low-value matches. In the various auctions described herein, “bidders” may include individuals, companies, and/or other entities providing a bid associated with an item available in the auction. Such a bid may be, for example, an amount (e.g., a dollar amount or other currency amount) proposed by the bidder for matching the bidder and the item. Additionally, in the various auctions described herein, “receivers” may include individuals, companies, and/or other entities providing an item for auction. In some instances, a receiver may provide an ask associated with the item. Each ask may be, for example, an amount (e.g., a dollar amount or other currency amount) that the receiver wishes to be paid for the item. In some examples, a receiver providing an item for auction may provide a different ask for respective bidders participating in the auction. Such different asks may represent the amount of money that the receiver wishes to be paid for the item by the different respective bidders. In some examples, a receiver may include one or more of the sellers described above, a job applicant, and/or any other entity providing an item for auction. An “item” provided for an auction may include the labor and/or services of the receiver (e.g., the services of a job applicant participating in the auction), a house, an apartment, real estate, and/or any other tangible, digital, and/or intangible item, service, or other object that the receiver wishes to convey to a winning bidder via an auction. Additionally, as will be described below, each bid and ask described herein may be either positive or negative in sign. Such signs may be indicative of the willingness (e.g., positive sign) or the unwillingness (e.g., negative sign) of the bidder/receiver to match the item. Typically, bids received from bidders are positive values/amounts, whereas asks received from receivers can typically be positive or negative values/amounts. The auctions described herein enable the bidders and receivers to obtain a wide range of information throughout the auction, such as before and/or after a bid has been placed. For example, the various systems utilized for auctions of the present disclosure enable bidders to view information provided by the receivers, and related to respective items, prior to entering a bid. Such systems also enable bidders to send messages to the receivers, to search for additional information related to, among other things, one or more receivers participating in the auction, one or more items available in the auction, and/or the particular item that the bidder is interested in bidding on, to modify a bid, and/or perform other actions related to the auction. Such systems may also enable receivers to send messages to the bidders, to search for additional information related to the bidder, to modify an ask entered by the receiver, and/or perform other actions related to the auction. Such auctions can take place in environments that include centralized systems in which a central server or other auction service computing device facilitates the auction between bidders and receivers participating in the auction. Such auctions can also take place in environments that include decentralized systems in which respective computing devices of the bidders and receivers are configured to facilitate the auction without the use of a central computing device. Some auctions described herein can be characterized as “one-sided auctions,” in which after an item is provided for the auction by a receiver, the receiver remains substantially passive as the auction progresses. Other auctions described herein can be characterized as “two-sided auctions,” in which the bidders and the receivers each actively participate in the auction as it progresses. In any of the example auctions described herein, additional bidders and/or additional receivers may be prohibited from joining an auction once the auction has begun (e.g., once registration for the auction has closed, and/or once an initial counter value has been generated).

In some examples, a method of the present disclosure includes a one-sided auction scenario in which a bid for an item is received from a bidder participating in the auction. The bid may be received during the auction, and the auction may be governed by a “counter” or other like mechanism presenting a “counter value” (e.g., a monetary or non-monetary indication of value) that descends over time. At any given time during the auction, the counter value may represent the price at which a transaction can be made. In an example one-sided auction scenario, the receiver may provide a respective item for auction without entering an ask corresponding to the item. Instead, during such an auction scenario any bid entered by a bidder may be given a value equal to a particular counter value of the series of counter values that is active at the time the bid is received. For example, in a one-sided auction a bidder may wait until the counter value decreases to a value that he or she is willing to pay for a particular item. When the counter value has decreased to a desirable value, the bidder may then enter a bid for the item, and the bid will be given a value equal to the counter value that is currently active. Additionally, in such a one-sided auction, the bidder may enter and/or modify a bid for an item, and the bid may have an amount and/or value that is less than the particular counter value of the series of counter values that is currently active. In such an example, the bidder may not be matched with the item corresponding to the entered bid until the counter value decreases to a particular counter value that is less than or equal to the bid amount. Once the particular counter value is less than or equal to the bid amount, the bidder and the item will be matched if the item has not yet been removed from the auction, the bidder has not yet been removed from the auction, and the bid value has not been modified to a new value that is lower than the particular counter value. Such a method may also include receiving an information request associated with the item from at least one of the bidders during the auction. Information may also be provided to the bidder, prior to receiving the bid, at least partially in response to receiving the information request. The item and the bidder may be matched at least partially in response to receiving the bid, and the bidder and the item may be removed from the auction once the item and the bidder are matched.

In another example, a method of the present disclosure includes a two-sided auction scenario in which at least one ask for an item is received from a receiver. The receiver providing the ask may be the receiver providing the item for auction, and each ask received from the receiver may correspond to a respective bidder participating in the auction. In this way, each ask may differ depending on the bidder with which the ask corresponds. The method also includes receiving a bid for the item from a bidder participating in the auction, and in such a method, the bid may be embodied by a first amount proposed by the bidder for matching the bidder and the item. In such a method, the ask provided by the receiver may be embodied by a second amount proposed by the receiver for matching the item and the bidder. For example, as noted above, such an ask may be an amount that the receiver asks and/or wishes to be paid for the item. Such a method also includes determining a difference between the first and second amounts. Such a difference may be referred to herein as a “bid-ask spread,” and may be a difference between the bid received for the item (from the bidder) and the ask (provided by the receiver) associated with the particular bidder that entered the bid. The method may also include generating a series of decreasing counter values, and matching the bidder and the item at least partially in response to the difference being greater than or equal to a particular counter value that is active when the bid is received. In example two-side auction scenarios, the value conveyed for matching the item may be equal to the average of the bid and the ask, and this value may be conveyed by the bidder to the receiver, or if it is negative debited by the bidder to the receiver. For example, if the value of the bid entered by the bidder for the item exceeded the value of the ask provided by the receiver, the bidder will convey the average of the bid and the ask to the receiver for the item. Similar to the example method described above, the bidder and the item are removed from the auction once the item and the bidder are matched.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, can refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment including a central auction service usable to implement example auctions described herein.

FIG. 2 is a block diagram depicting an example auction service computing device usable to implement example auctions described in connection with the environment of FIG. 1.

FIG. 3 is a block diagram depicting an example user computing device usable to implement example auctions described in connection with the environment of FIG. 1.

FIG. 4 is a block diagram depicting an example distributed environment usable to implement example auctions described herein.

FIG. 5 is a block diagram depicting a further example user computing device usable to implement example auctions described in connection with the environment of FIG. 4.

FIG. 6A is a flow diagram that illustrates example methods associated with an example two-sided auction implemented in the environment illustrated in either FIG. 1 or FIG. 4.

FIG. 6B is a block diagram associated with the example flow diagram of FIG. 6A and illustrating an example user interface provided by a user computing device.

FIG. 6C is another block diagram associated with the example flow diagram of FIG. 6A and illustrating bids and asks provided during an example two-sided auction.

FIG. 6D is a further block diagram associated with the example flow diagram of FIG. 6A and illustrating a counter value that has decreased during the auction.

FIG. 6E is a further block diagram associated with the example flow diagram of FIG. 6A and illustrating the removal of various auction participants.

FIG. 7A is a flow diagram that illustrates example methods associated with an example one-sided auction described herein implemented in the environment illustrated in either FIG. 1 or FIG. 4.

FIG. 7B is a block diagram associated with the example flow diagram of FIG. 7A and illustrating an example user interface provided by a user computing device.

FIG. 7C is another block diagram associated with the example flow diagram of FIG. 7A and illustrating bids provided during an example one-sided auction.

FIG. 7D is a further block diagram associated with the example flow diagram of FIG. 7A and illustrating the removal of various auction participants.

### DETAILED DESCRIPTION

### Overview

Examples described herein provide environments, systems, and methods associated with various one-sided and two-sided auctions. In any of the examples described herein, the auction may be governed by a series of counter values generated by one or more computing devices being used by the auction participants (e.g., bidders and/or receivers) and/or by one or more central auction service computing devices facilitating the auction. Such counter values may descend as the auction proceeds, and the counter values may be made available to all auction participants during the auction. A bidder participating in such an auction may enter a bid corresponding to an item provided by one of the receivers participating in the auction, and the bidder may be matched with the item based at least partly on the particular counter value that is active when the bid from the bidder is received. Additionally, once a bidder has been matched with an item, the bidder and the item will be removed from the auction. The auction may proceed until each of the bidders has been matched with a corresponding item, until each of the items available in the auction has been matched with respective bidder, and/or until another stopping condition is reached. For example, one such alternative stopping condition may be that the counter value is less than or equal to a predetermined threshold value, such as zero.

Some auctions described herein may be one-sided auctions in which a receiver may provide a respective item for auction without entering an ask corresponding to the item. At the beginning of an example one-sided auction, an initial counter value may be provided to all auction participants, and the initial counter value may begin to decrease. A bidder participating in such an auction may wait to enter a bid until the counter value reaches a value that he or she is willing to pay for a particular item available in the auction. When the counter value has decreased to such a value, the bidder may enter a bid for the item, and the bid will be given a value equal to the counter value that is currently active. In such an example auction, the bidder may be instantly matched with the item corresponding to the bid in response to placement of the bid by the bidder. Since the receiver is only a passive participant in a one-sided auction, the receiver may not tender a counter offer or other similar ask associated with the item. Additionally, as noted above, in such a one-sided auction, the bidder may enter and/or modify a bid for an item at any time during the auction. In some examples, a newly entered and/or modified bid may have an amount and/or value that is less than the particular counter value of the series of counter values that is currently active. In such an example, the bidder may not be matched with the item corresponding to the entered bid until the counter value decreases to a particular counter value that is less than or equal to the bid amount. Put another way, the bidder may be matched with the item once the bid entered by the bidder is greater than or equal to the particular counter value. Once the particular counter value is less than or equal to the bid amount, the bidder and the item will be matched if the item has not yet been removed from the auction, the bidder has not yet been removed from the auction, and the bid value has not been modified to a new value that is lower than the particular counter value. In still further example one-sided auctions, the receiver may provide a reserve price for the item. In such examples, the bidder may be matched with the item when the difference between the bid provided by the bidder and the reserve price entered by the receiver is greater than or equal to the particular counter value.

Additionally, during any of the one-sided or two-sided auctions described herein, the bidder may be provided with a dashboard and/or other functionality via a computing device used by the bidder during the auction. The dashboard may enable the bidder to obtain information associated with the item, send a message to a receiver corresponding to the item, and/or acquire any additional information that may be useful to the bidder during the auction. In particular, systems of the present disclosure may enable the bidder to obtain such information prior to placing a bid for the item. In any of the example auctions described herein, the receiver may also be provided with a dashboard and/or other functionality via a computing device used by the receiver during the auction. The dashboard may enable the receiver to obtain information associated with the bidders participating in the auction, send a message to a bidder, and/or acquire any additional information that may be useful to the receiver during the auction. In an example one-sided auction, once the bidder and the item have been matched, the bidder and the item may be removed from the auction, and the auction may proceed until all remaining bidders are matched with a respective item, until all remaining items associated with the auction have been matched to a respective bidder, and/or until another stopping condition is reached.

For instance, in an example one-sided auction in which a receiver provides a house as an item available via the auction, the receiver may provide descriptive information associated with the house (e.g., square footage, number of bedrooms, number of bathrooms, lot size, address, school district, etc.) as part of registering for the auction. Such information may be provided to the bidders from the receiver directly or, alternatively, such information may be provided to the bidders via a central auction service computing device. Once registration for the auction is complete (e.g., each of the bidders and receivers have provided all necessary information), the auction service computing device and/or the respective computing devices of the bidders and receivers may generate a counter value that descends over the course of the auction. An initial counter value of, for example, $600,000 may be generated. If this value is more than a particular bidder wishes to pay for the house offered by the receiver, the bidder may wait until the counter value decreases to a more desirable value. Of course, by waiting, the bidder takes the risk that another bidder participating in the auction may enter a bid and, thus, be matched with the house. Once the bidder enters a bid for the house during an example one-sided auction, the bidder will be matched with the house, and the bidder and the house will be removed from the auction.

In a two-sided auction, on the other hand, a bidder may submit a bid for an item, and a receiver providing the item for auction may submit one or more asks associated with the item, wherein each of the asks corresponds to a respective one of the bidders participating in the auction . In such examples, the bids and asks of the respective bidders and receivers participating in the auction may be submitted prior to the auction commencing. Further, each ask provided by the receiver may comprise an amount that the receiver asks to be paid by the respective bidder should a match occur between the respective bidder and the item. Additionally, one or more computing devices being utilized for the auction, and/or a central auction service computing device, may generate a series of decreasing counter values that may be accessible by each of the bidders and receivers. Once such a two-sided auction commences, one or more of the computing devices may determine a difference (e.g., a bid-ask spread) between the respective bids and asks corresponding to each item available via the auction. The computing devices may also match a respective bidder with an item at least partly in response to the difference between the bid provided by the bidder and an ask provided by the receiver (and corresponding to that respective bidder) being greater than or equal to a particular counter value active when the bid is received. As described above with respect to a one-sided auction, the bidder and the item may be removed from the auction once the bidder and the item have been matched.

For instance, in an example two-sided auction in which a receiver offers his or her services (e.g., for a job opening) as an item available via the auction, the receiver may provide descriptive information about themselves (e.g., undergraduate degree, graduate degree, name, address, email address, current employer, etc.) as part of registering for the auction. Various bidders participating in the auction may also provide information associated with respective job openings provided by the corresponding bidder (e.g., the title, office location, a description of the duties required, a desired educational background, etc.) as part of registering for the auction. Such information may be exchanged between the bidders and receivers directly or, alternatively, such information may be exchanged via a central auction service computing device.

The receiver may also provide an ask, associated with providing his or her services to one or more of the bidders registered in the auction. In such an example, each ask may be a dollar and/or other amount proposed by the receiver for matching his or her services (i.e., the item) with the job opening of a respective bidder. Likewise, one or more of the bidders may provide a bid associated with matching services of a respective receiver (i.e., the item) and the bidder. Each bid may be a dollar and/or other amount (e.g., a salary) proposed by the bidder for matching the bidder with the services of a respective receiver. Once registration for the auction is complete (e.g., each of the bidders and receivers have provided all necessary information), the auction service computing device and/or the respective computing devices of the bidders and receivers may generate a counter value that descends over the course of the auction. As the counter value decreases, a particular bidder may be matched with the services of a respective receiver once a difference between the ask entered by the receiver and a bid entered by a bidder (e.g., the bid-ask spread) is greater than or equal to the particular counter value that is currently active. It is understood that in any of the two-sided auctions described herein, bidders may modify their bids, and receivers may modify their asks, at any time during the auction. Once the bidder and the item (e.g., the services of the receiver) are matched, the bidder and the item will be removed from the auction. While example auctions described herein may refer to employers and/or other entities as “bidders,” potential employees as “receivers,” and the services of the respective receivers as the “items” offered for auction, it is understood that any of the examples described herein may apply to auctions in which, for example, employers and/or other entities on one side of the auction are “receivers,” potential employees or other participants on an opposite side of the auction are “bidders,” and the job openings provided by the respective employers are the “items” offered for auction. For ease of explanation, however, employers and/or other entities shall be considered as “bidders,” potential employees shall be considered as “receivers,” and the services and/or labor of each respective receiver available in the auction shall be considered as the “items” offered for auction, unless otherwise specified. Such designations should not be construed as limiting in any way. It is understood that the bidders and receivers, and the corresponding bids and asks described herein may be reversible and/or interchangeable depending on the example auction, and the examples described herein are merely for illustration.

In any of the example auctions described herein, the bidders and receivers participating in the auction may be provided with dashboards and/or other functionality enabling information to be shared before and/or during the auction. In particular, a bidder wishing to obtain further information associated with the item provided by the receiver may request such information directly from the receiver via the one or more dashboards. The bidder may also send one or more messages to the receiver, perform one or more searches, and/or perform a variety of additional tasks via the dashboard and prior to placing a bid. Such dashboards may also enable the receiver to obtain a variety of additional information associated with the various bidders participating in the auction. Further, in any of the examples described herein, matches in which the mutual (e.g., cumulative or net) declared willingness of the bidder and receiver to pay a high price for a match associated with a particular item (e.g., “high-value matches”) are made earlier in the auction than other matches in which the declared willingness of the bidder and receiver to pay a relatively lower price for a match (e.g., “low-value matches”) are made. Governing each of the example auctions described herein in accordance with a series of descending counter values results in the high-value matches described above taking place before the relatively low-value matches. Accordingly, example auctions of the present disclosure may result in more economically efficient outcomes than conventional auctions.

For example, one difference between descending-type auctions of the present disclosure and either a simultaneous or ascending-type auction is that in the descending-type auctions described herein, participants quickly learn when a particularly high-value match exists by that match being made early in the process. This allows participants to avoid the time and hassle of researching or interviewing a potential match that will be claimed by a rival. In a simultaneous or ascending-type auction, by contrast, participants can at best learn that potential rivals' matches are not especially poor (because they have chosen not to drop out in early rounds), but such participants do not learn of high match values until a match is actually finalized (once all competitors drop out). As a result, simultaneous or ascending-type auctions make it impossible for participants to search for matches efficiently, while example descending-type auctions of the present disclosure ensure approximately efficient searches.

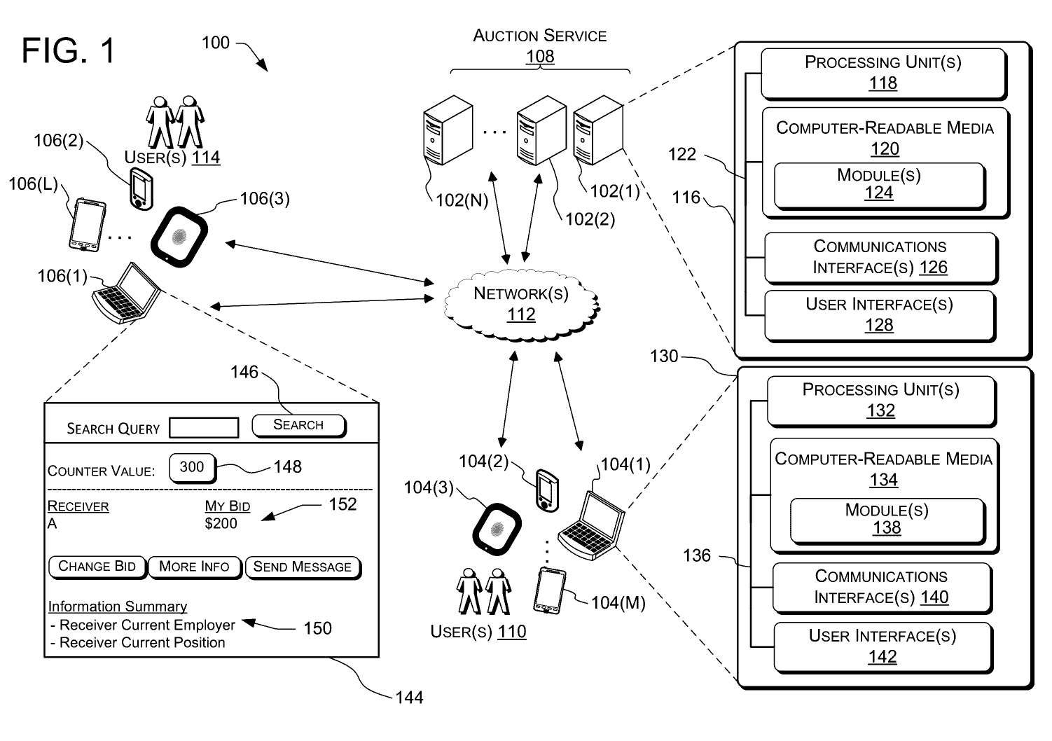

Various environments, configurations of electronic devices, and methods operating and/or facilitating an auction are described further with reference to FIGS. 1-7D. While many examples described herein relate to servers and other non-consumer electronic devices, other types of electronic devices can be used, e.g., as discussed with reference to FIG. 1.

### Illustrative Environment

FIG. 1 shows an example environment 100 including an example system configured to operate an auction, and/or perform one or more of the methods described herein. In the illustrated example, one or more of the various devices and/or components of the environment 100 may comprise a system of the present disclosure, and such devices and/or components of the environment 100 may include computing device(s) 102(1)-102(N) (individually or collectively referred to herein with reference 102), where N is any integer greater than or equal to 1. The example environment 100 may also include computing devices 104(1)-104(M) (individually or collectively referred to herein with reference 104), where M is any integer greater than or equal to 1 and computing devices 106(1)-106(L) (individually or collectively referred to herein with reference 106), where L is any integer greater than or equal to 1. Although illustrated as, e.g., desktop computers, laptop computers, tablet computers, cellular phones, personal digital assistants, and the like, the computing devices 102, 104, and 106 can include a diverse variety of device categories, classes, or types and are not limited to a particular type of device. In the illustrated example, computing devices 102 can be computing devices in an auction service 108. In some examples, the auction service 108 may comprise a cluster of computing devices and/or a 108 cloud service. In the illustrated example, computing devices 104 and 106 can be clients of the auction service 108 and can submit bids, asks, modified bids, modified asks, information requests, messages, search queries, and/or other information to the auction service 108. Computing devices 104 and 106 can receive bids, asks, modified bids, modified asks, information requests, messages, search queries, and/or other information or content from the auction service 108. The computing devices 102 in auction service 108 can, e.g., share resources, balance load, increase performance, or provide fail-over support or redundancy.

In some examples, computing devices e.g., computing devices 102(1) and 102(2), can communicate with one another to participate in or carry out one or more of the operations described herein. For example, two or more of the computing devices 102 may cooperate to perform one or more steps or operations of an auction, such as a descending price auction, or other type of auction. Additionally, one or more of the computing devices 102, 104, and 106 may be operated by one or more respective users. For example, in an auction of the present disclosure, one or more of the computing devices 104 may be operated by user(s) 110. In such examples, one or more of the user(s) 110 may comprise a receiver participating in an auction via one or more network(s) 112 of the present disclosure. Likewise, one or more of the computing devices 106 may be operated by user(s) 114. In such examples, one or more of the user(s) 114 may comprise a bidder participating in the auction. As noted above, one or more “bidders” of the present disclosure may include individuals, companies, and/or other entities providing a bid associated with an item available in the auction. Such a bid may be, for example, an amount (e.g., a dollar amount or other currency amount) proposed by the bidder for matching the bidder and the item. Additionally, one or more “receivers” of the present disclosure may include individuals, companies, and/or other entities providing an item for auction. In some instances, a receiver may provide an ask associated with the item. Each ask may be, for example, an amount (e.g., a dollar amount or other currency amount) proposed by the receiver for matching the bidder and the item provided by the receiver. For example, as described above, an ask may be an amount that the receiver asks and/or wishes to be paid for the item. Such auctions will be described in greater detail below.

The various computing devices 102, 104, and 106 can communicate with each other or with other computing devices via the network(s) 112. In some examples, computing devices 102, 104, and 106 can also communicate with external devices via network(s) 112. For example, network(s) 112 can include public networks such as the Internet, private networks such as an institutional or personal intranet, or combination(s) of private and public networks. Network(s) 112 can also include any type of wired or wireless network, including but not limited to local area networks (LANs), wide area networks (WANs), satellite networks, cable networks, Wi-Fi networks, WiMAX networks, mobile communications networks (e.g., 3G, 4G, and so forth) or any combination thereof. Network(s) 112 can utilize communications protocols, such as, for example, packet-based or datagram-based protocols such as Internet Protocol (IP), Transmission Control Protocol (TCP), User Datagram Protocol (UDP), other types of protocols, or combinations thereof. Moreover, network(s) 112 can also include a number of devices that facilitate network communications or form a hardware infrastructure for the networks, such as switches, routers, gateways, access points, firewalls, base stations, repeaters, backbone devices, and the like.

Different networks have different characteristics, e.g., bandwidth, latency, accessibility (open, announced but secured, or not announced), or coverage area. The type of network 112 used for any given connection between, e.g., a computing device 104, 106 and auction service 108 can be selected based on these characteristics and on the type of interaction. Additionally, as will be described below, various file creation, modification, compression, encryption, and/or other processes performed by components of the systems described herein may improve the functionality of such networks. In particular, such processes may generate one or more packets, signals, files, and/or other content, such as compressed content. Transferring or processing such content may require reduced memory, processor, and/or other system resources. As a result, such content may be transmitted via the network 112 at faster speeds, and using reduced bandwidth. Accordingly, the generation and/or use of such content may result in improved network performance.

Details of an example computing device 102(1) are illustrated at inset 116. The details of the example computing device 102(1) can be representative of others of computing devices 102. However, each of the computing devices 102 can include additional or alternative hardware and/or software components. Still referring to the example of FIG. 1, computing device 102(1) can include one or more processing unit(s) 118 operably connected to one or more computer-readable media 120, e.g., memories, such as via a bus 122, which in some instances can include one or more of a system bus, a data bus, an address bus, a Peripheral Component Interconnect (PCI) Express (PCIe) bus, a PCI bus, a Mini-PCI bus, and any variety of local, peripheral, or independent buses, or any combination thereof. In some examples, plural processing units 118 can exchange data through an internal interface bus (e.g., PCIe), rather than or in addition to network 112. While the processing units 118 are described as residing on the computing device 102(1), in this example, the processing units 118 can also reside on different computing devices 102, 104, or 106 in some examples. In some examples, at least two of the processing units 118 can reside on different computing devices 102, 104, or 106. In such examples, multiple processing units 118 on the same computing device 102, 104, or 106 can use a bus 122 of the computing device 102, 104, or 106 to exchange data, while processing units 118 on different computing devices 102, 104, or 106 can exchange data via network(s) 112.

Computer-readable media described herein, e.g., computer-readable media 120, include computer storage media and/or communication media. Computer storage media includes tangible storage units such as volatile memory, nonvolatile memory, and/or other persistent and/or auxiliary computer storage media, removable and non-removable computer storage media implemented in any method or technology for storage of information such as computer-readable instructions, data structures, program modules, or other data. Computer storage media includes tangible or physical forms of media included in a device or hardware component that is part of a device or external to a device, including but not limited to RAM, static RAM (SRAM), dynamic RAM (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or memories, storage, devices, and/or storage media that can be used to store and maintain information for access by a computing device 102, 104, or 106. In contrast to computer storage media, communication media embodies computer-readable instructions, data structures, program modules, or other data in a modulated data signal, such as a carrier wave, or other transmission mechanism. As defined herein, computer storage media does not include communication media. In some examples, computer-readable media 120 can store instructions executable by the processing unit(s) 118, and the processing units 118 can be internal or external (e.g., virtual processing unit) to the computing device 102.

Computer-readable media 120 can store, for example, computer-executable instructions, an operating system, and/or other computer program instructions. The computer-readable media 120 can also store one or more module(s) 124 associated with an auction of the present disclosure. Such modules 124 may include, for example, a communication module, an encryption module, a matching module, a payment module, a compression module, and/or any other modules, programs, or applications that are loadable and executable by processing unit(s) 118.

Processing unit(s) 118 can be or include one or more single-core processors, multi-core processors, CPUs, GPUs, GPGPUs, or hardware logic components configured, e.g., via specialized programming from modules or APIs, to perform functions described herein. For example, and without limitation, illustrative types of hardware logic components that can be used in or as processing units 118 include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Digital Signal Processors (DSPs), and other types of customizable processors. For example, a processing unit 118 can be a hybrid device, such as a device from ALTERA or XILINX that includes a CPU core embedded in an FPGA fabric. These or other hardware logic components can operate independently or, in some instances, can be driven by a CPU. In some examples, at least some of computing device(s) 102, 104, or 106 can include a plurality of processing units 118 of multiple types. For example, the processing units 118 in computing device 102(3) can be a combination of one or more GPGPUs and one or more FPGAs. Different processing units 118 can have different execution models, e.g., as is the case for graphics processing units (GPUs) and central processing unit (CPUs).

The communications interface(s) 126 may be connected via the bus 122 to processing units 118 to enable wired or wireless communications between computing device(s) 102 and other networked computing devices 102, 104, or 106 over network(s) 112. Such communications interface(s) 126 can include one or more transceiver devices, e.g., network interface controllers (NICs) such as Ethernet NICs or other types of transceiver devices, to send and receive communications over a network. The processing units 118 can exchange data through respective communications interface(s) 126. In some examples, the communications interface 126 can be a PCI Express (PCIe) transceiver, and the network 112 can be a PCIe bus. In some examples, the communications interface 126 can include, but is not limited to, a transceiver for cellular (3G, 4G, or other), WI-FI, Ultra-wideband (UWB), BLUETOOTH, or satellite transmissions. The communications interface 126 can include a wired I/O interface, such as an Ethernet interface, a serial interface, a Universal Serial Bus (USB) interface, an INFINIBAND interface, or other wired interfaces. For simplicity, these and other components are omitted from the illustrated computing device 102(1).

In some examples, computing device 102 can also include one or more user interface(s) 128 configured to permit a user, e.g., a data analyst or neural-network administrator, to operate one or more of the modules 124 and/or other components of the computing device 102 before, during, and/or after, for example, an auction of the present disclosure. In an example embodiment, a user interface 128 can include one or more output devices configured for communication to a user or to another computing device 102, 104, 106. Output devices can be integral or peripheral to a computing device 102, 104, 106. Examples of output devices can include a display, a printer, audio speakers, beepers, or other audio output devices, a vibration motor, linear vibrator, or other haptic output device, and the like. For example, the user interface 128 can include a display, such as an organic light-emitting-diode (OLED) display, a liquid-crystal display (LCD), a cathode-ray tube (CRT), or another type of visual display. Such a display can be a component of a touchscreen, or can include a touchscreen. User interface 128 can also include one or more input devices, integral or peripheral to a computing device 102, 104, 106. The input devices can be user-operable, or can be configured for input from other computing device 102, 104, 106. Examples of input devices can include, e.g., a keyboard, keypad, a mouse, a trackball, a pen sensor or smart pen, a light pen or light gun, a game controller such as a joystick or game pad, a voice input device such as a microphone, voice-recognition device, or speech-recognition device, a touch input device such as a touchscreen, a gestural or motion input device such as a depth camera, a grip sensor, an accelerometer, another haptic input, a visual input device such as one or more cameras or image sensors, and the like.

Details of an example computing device 104(1) are illustrated at inset 130. The details of example computing device 104(1) can be representative of others of computing device(s) 104 or 106. However, each of the computing device(s) 104 can include additional or alternative hardware and/or software components. Computing device 104(1) can include one or more processing unit(s) 132 operably connected to one or more computer-readable media 134, e.g., via a bus 136. The processing unit(s) 132 can be the same as or similar to the example processing units 118 discussed above. Additionally, the computer-readable media 134 can be the same as or similar to the example computer-readable media 120 described above. For example, computer-readable media 134 can include one or more computer storage media. Further, the bus 136 can be the same as or similar to the example bus 122 described above.

Computer-readable media 134 can store, for example, computer-executable instructions, an operating system, and/or other computer program instructions. The computer-readable media 134 can also store one or more module(s) 138 programs, or applications that are loadable and executable by processing unit(s) 132. Some examples of modules 138 are discussed above with reference to modules 124. As will be described below, the modules 138 can include modules that are the same as modules 124 and/or that are different from the modules 124.

Computing device 104 can also include one or more communications interfaces 140 connected via the bus 136 to processing unit(s) 132 to enable wired or wireless communications between computing device(s) 104 and other networked computing devices 102 or 106 involved in one or more auctions or other computing functions over network(s) 112. The communications interfaces 140 may be the same as or similar to the communications interface(s) 126 described above.

In some examples, computing device 104 can include a user interface 142 connected via the bus 136 to processing unit(s) 132. For example, computing device 104(1) can include a user interface 142 configured to enable a user 110 of the computing device 104(1) to control or otherwise interact with the computing device 104(1). Additionally or alternatively, the user interface 142 may be configured to enable a user 110 of the computing device 104(1) to control or otherwise interact with one or more of the computing devices 106 via the network(s) 112. For example, processing unit(s) 132 can receive inputs of user actions via user interface 142 and transmit corresponding data via communications interface(s) 140 to computing device(s) 102 or 106. The user interfaces 142 may be the same as or similar to the user interfaces 128 described above.

In some examples, the computing devices 106 described herein may be the same as or similar to the computing devices 104, and the computing devices 106 may include any or all of the components described above with respect to the computing devices 104. Additionally, any of the computing devices 102, 104, 106 described herein may be configured to provide one or more dashboards 144 or other user interfaces such as, via a display or other user interface of the computing device. As illustrated with respect to the computing device 106(1) of FIG. 1, an example dashboard 144 may provide a variety of information and functionality to a user 114 including, among other things, a search tool 146 enabling the user 114 to search for information associated with an item associated with an auction, a plurality of items available in the auction, a participant (e.g., a bidder and/or a receiver) registered for the auction, items available in past auctions, and/or other content. Such an example dashboard 144 may also include a portion that provides a counter value to the user 114 in real time. The dashboard 144 may also provide information 150 associated with, related to, and/or indicative of one or more auction participants, as well as one or more additional tools 152 enabling the user 114 to, for example, modify an ask, modify a bid, request additional information from the auction service 108 and/or an auction participant, send a message to an auction participant, and/or perform one or more additional tasks associated with the auction. As noted above, such a dashboard 144 may be provided to, and may be tailored to, a bidder and/or a receiver during an auction. Further details regarding example dashboards will be provided below.

### Illustrative Components

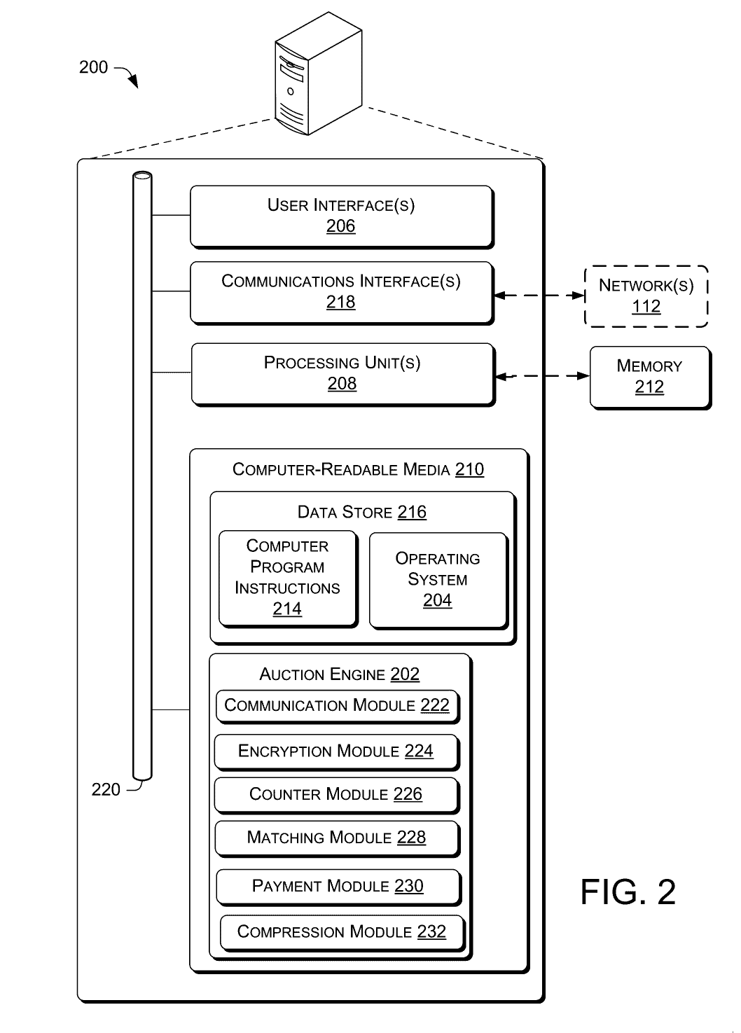

FIG. 2 is an illustrative diagram that shows example components of an auction service computing device 200, which can be similar to or the same as one or more of computing device(s) 102,106 and which can be a central server or other computing device configured to operate and/or otherwise facilitate an auction between two or more entities according to various examples described herein. Auction service computing device 200 can implement an auction engine 202, an operating system 204, and/or any other software or hardware component configured to operate such an auction.

Auction service computing device 200 can include or be connected to a user interface 206, which can be similar to or the same as the user interface 128 described above with respect to FIG. 1. The user interface 206 can include various types of output devices and/or input devices described above with reference to user interface 128. The user interface 206 can also include one or more input/output (I/O) interfaces to allow auction service computing device 200 to communicate with input, output, or I/O devices. Examples of such devices can include components of user interface 206 such as user-operable input devices and output devices described above with reference to user interface 128.

The auction service computing device 200 can include one or more processing unit(s) 208, which can be similar to or the same as processing unit(s) 118 described above with respect to FIG. 1. Processing units 208 can be operably coupled to the I/O interface and/or other user interface(s) 206, as well as to at least one computer-readable media 210, discussed below. Processing unit(s) 208 can include, e.g., processing unit types described above such as CPU- or GPGPU-type processing unit(s). In some examples, processing unit(s) 208 can include or be connected to a memory 212, e.g., a RAM or cache.

In some examples, computer-readable media 210 of the auction service computing device 200 can be similar to or the same as computer-readable media 120 described above with respect to FIG. 1, and can store a plurality of modules of the auction engine 202. The computer-readable media 210 can also store the operating system 204, as well as other items that will be described below. Processing unit(s) 208 can be configured to execute modules of the plurality of modules of the auction engine 202. For example, computer-executable instructions and/or other computer program instructions 214 stored within a data store 216 of the computer-readable media 210 can, upon execution, configure a computer such as an auction service computing device 200 to perform operations described herein with reference to the modules of the plurality of modules. The modules stored in the computer-readable media 210 can include instructions that, when executed by the one or more processing units 208, cause the one or more processing units 208 to perform operations described below.

In some examples, data store 216 can include data storage, structured or unstructured, such as a database (e.g., a Structured Query Language, SQL, or NoSQL database) or data warehouse. In some examples, data store 216 can include a corpus or a relational database with one or more tables, arrays, indices, stored procedures, and so forth to enable data access. Data store 216 can store data for the operations of processes, applications, components, or modules stored in computer-readable media 210 or computer instructions in those modules executed by processing unit(s) 208. In some examples, the computer program instructions 214 stored in the data store 216 may comprise instructions corresponding to processes described herein or to other software executable by processing unit(s) 208.

In some examples, the operating system 204 can include components that enable or direct the auction service computing device 200 to receive data via various inputs (e.g., user controls, network or communications interfaces, memory devices, or sensors), and process the data using the processing unit(s) 208 to generate output. The operating system 204 can further include one or more components that present the output (e.g., display an image on an electronic display, store data in memory, and/or transmit data to another computing device).

The auction service computing device 200 can also include a communications interface 218, which can be similar to or the same as communications interface 132 described above with respect to FIG. 1. For example, communications interface 218 can include a transceiver device such as a network interface controller (NIC) to send and receive communications over a network 112 (shown in phantom), e.g., as discussed above. As such, the auction service computing device 200 can have network capabilities. For example, the auction service computing device 200 can exchange data with computing devices 102, 104, or 106 (e.g., laptops, computers, and/or servers) via one or more network(s) 112, such as the Internet.

In some examples, the processing unit(s) 208 can access the module(s) on the computer-readable media 210 via a bus 220, which can be similar to or the same as bus 122 described above with respect to FIG. 1. User interface 206 and communications interface 218 can also communicate with processing unit(s) 208 via bus 220. The modules of the auction engine 202 stored on computer-readable media 210 can include one or more modules (e.g., shell modules, or API modules) which are illustrated as a communication module 222, an encryption module 224, a counter module 226, a matching module 228, a payment module 230, and a compression module 232. In the auction engine 202, the number of modules can vary higher or lower, and modules of various types can be used in various combinations. For example, functionality described associated with the illustrated modules can be combined to be performed by a fewer number of modules or APIs or can be split and performed by a larger number of modules or APIs. For example, the communication module 222 and the encryption module 224 can be combined in a single module that performs at least some of the example functions described below of those modules. Additionally or alternatively, the matching module 228 and the payment module 230 can be combined in a single module that performs at least some of the example functions described below of those modules. Further, the compression module 232 and the encryption module 224 can be combined in a single module that performs at least some of the example functions described below of those modules. In some examples, computer-readable media 210 may have thereon computer-executable instructions, the computer-executable instructions, upon execution, configuring a computer to perform operations described herein.

Example functionality associated with the modules 222, 224, 226, 228, and 230 of the auction engine 202 will be described in greater detail below with respect to example auctions. However, in some example systems of the present disclosure, the communication module 222 may be configured to receive information from a bidder of a plurality of bidders, and to receive information from a receiver of a plurality of receivers. Such information may be received, for example, using the communications interface 218 and via the network 112. In such examples, the information received from a bidder may include a name, address, date of birth, nationality, current employer, social security number, bank account number, telephone number, email address, names and contact information of references, a job description, a description of the job requirements, a location of the job, a proposed salary, a proposed title, and/or other information describing the bidder. Such information may be provided by the bidder in order to, for example, register for an auction. Further, the information received from a receiver may include information describing an item provided for auction by the receiver. As noted above, an example item may be the labor and/or services of the receiver, a house, an apartment, real estate, and/or any other tangible or intangible item or object that the receiver wishes to convey to a winning bidder via an auction. Accordingly, in examples in which the item comprises, for example, the services of the receiver (e.g., for a job opening associated with one or more of the bidders), such information may include the receiver's resume and/or CV, the receiver's work history, the receiver's transcript(s), a listing of one or more employee references, a writing sample, and/or other information. In examples in which the item comprises a house or other tangible object, the information may include a color, price, age, make, and/or model, of the object. Such information may also include any other information descriptive of the particular item provided for auction by the receiver.

For example, in some embodiments the communication module 222 may be configured to receive first information from a computing device 106 of the bidder via the network 112, and to receive second information from a computing device 104 of the receiver via the network 112. In such examples, communications module 222 may comprise a component of a central server or other central computing device 102 facilitating the auction. In other examples, the communications module 222 may be a component of an application of one of the computing device 106 of the bidder or the computing device 104 of the receiver. In such examples, the auction may proceed without the use of a central server or other central computing device 102 facilitating the auction.

In some example auctions, the communication module 222 may be configured to receive, from the bidder and during the auction, an information request associated with the item provided by the receiver. In such examples, the communication module 222 may also be configured to provide information associated with the item to the computing device 106 of the bidder. The communication module 222 may provide such information to the computing device 106 of the bidder prior to receiving a bid on the item from the bidder, or from one or more additional bidders participating in the auction. Additionally, the communication module 222 may provide such information to the computing device 106 of the bidder at least partly in response to receiving the information request.

The communication module 222 may also be configured to receive a bid from the computing device 106 of at least one bidder of a plurality of bidders participating in the auction. Such a bid may comprise, for example, an amount proposed by the bidder for matching the bidder with the item that is provided for auction by the receiver. In auctions in which more than one item is available, the bid may be an amount proposed by the bidder for matching the bidder with a particular item. Additionally, in some auctions, the communication module 222 may be configured to receive multiple bids from the computing devices 106 of multiple respective bidders. In such examples, each bid may comprise an amount proposed by the respective bidder for matching the respective bidder with a corresponding one of the items.

Further, in example two-sided auctions (e.g., auctions in which the receiver is an active participant), the communication module 222 may also be configured to receive an ask from the computing device 104 of the receiver. In such example auctions, the ask may comprise an amount proposed by the receiver for matching the item, provided by the respective receiver for auction, and the bidder. In particular, the ask may be an amount that the receiver asks to be paid for the item. In some two-sided auctions, the communication module 222 may be configured to receive multiple asks from computing devices 104 of multiple respective receivers. In such examples, each ask may comprise an amount proposed by the respective receiver for matching the item provided by the respective receiver with a corresponding one of the bidders. Example communication modules 222 of the present disclosure may also have additional functionality as will be described below.

The encryption module 224 may be configured to perform a variety of encryption, decryption, file conversion, file modification, and/or other functions associated with one or more example auctions of the present disclosure. For example, the encryption module 224 may be configured to encrypt the various information, messages, requests, bids, asks, and/or other electronic content (collectively referred to herein as “auction content”) received by the communication module 222 before, during, and/or after an auction. For example, such auction content may be received by the communication interface 218 and/or the communication module 222 in the form of signals, files, and/or packets, and such auction content may include an encryption key or other encoded information identifying, for example, the sender of the auction content. The encryption module 224 may receive such auction content as inputs, and may decrypt the auction content in order to authenticate the encryption key. The encryption module 224 may also authenticate the encryption key using one or more accepted receiver lists or other like information stored within the computer-readable media 210. The encryption module 224 may also verify the identity of the sender and/or the intended recipient of such auction content based at least partly on matching and/or otherwise authenticating the encryption key using the information stored within the computer readable media 210. In any of the example embodiments described herein, the encryption module 224 may perform any digital signature scheme or other cryptographic authentication scheme.

In still further examples, the encryption module 224 may be configured to encrypt such auction content prior to transmitting such content using the communication interface 218 and via the network 112. For example, the encryption module 224 may be configured to generate one or more encryption keys, and to embed and/or otherwise incorporate such encryption keys within the auction content prior to transmitting such auction content to a bidder, a receiver, and/or other intended recipient. Accordingly, the various information, messages, requests, bids, asks, and/or other auction content may be augmented, and/or otherwise altered by the encryption module 224 prior to being transmitted. As part of such an encryption process, and/or as a separate process associated with one or more of the example auctions described herein, encryption module 224 and/or the compression module 232 may modify the various information, messages, requests, bids, asks, and/or other auction content prior to transmitting such content using the communication interface, 218 and via the network 112. For example, the compression module 232 may compress, zip, and/or otherwise modify auction content, generated at least in part by the encryption module 224, thereby generating modified auction content prior to transmission. Relative to the original auction content, such modified auction content may have a reduced size, reduced bandwidth requirements, reduced memory requirement, and/or other such reduced characteristic. As a result, such modified auction content may be transmitted via the network 112 more quickly, may reduce the bandwidth and/or other system resources required for transmission, and/or may reduce the memory requirements of one or more of the computing devices 200, 102, 104, 106 associated with storing such content. As a result, generation and utilization of such modified auction content by the encryption module 224 and/or by the compression module 232 may improve the efficiency of the system, components thereof, the network 112, and/or of the auction facilitated by the system.

The counter module 226 may be configured to generate a series of decreasing counter values during an auction of an item. For example, in auctions such as descending price auctions, the counter module 226 may generate an initial counter value that is greater than a bid proposed by at least one bidder of a plurality of bidders, and that is greater than an ask proposed by a receiver of a plurality of receivers. The counter module 226 may, during the course of the auction, generate a series of additional counter values, and the values included in the series of counter values may decrease over time from the initial counter value.

In general, a bidder and an item that is provided for auction by the receiver may be matched based at least partly on a particular counter value of the series of counter values that is currently active in real time. In some example auctions, the particular counter value may be active when a bid is received from the bidder for the item. For example, in a one-sided descending price auction a bidder may submit a bid for the item at any time, and the system may automatically set the amount of the bid received from the bidder equal to the particular counter value that is active at the time the bid is received. In such an auction, the receiver may be a passive participant in the auction. For example, the receiver may set a minimum ask or other such reserve price for the item before the auction begins, and may not be permitted to submit a revised ask associated with the item, or otherwise affect the price of the item, during the auction. Accordingly, in such one-sided descending price auctions, the bid received from the bidder may comprise the particular counter value that is active when the bid is received. Alternatively, as described above, in such one-sided auctions the bidder may enter and/or modify a bid having an amount that is less than the particular counter value that is currently active, and in such examples, a match may be made between the bidder and the item when the bid that is entered and/or modified by the bidder is greater than or equal to the particular counter value. In still further example one-sided auctions in which the receiver has entered a minimum ask or other such reserve price for the item before the auction begins, a match may be made between the bidder and the item when the difference between the bid that is entered and/or modified by the bidder and the minimum ask or other such reserve price is greater than or equal to the particular counter value. In a two-sided auction on the other hand, the receiver has the ability to enter an ask price before the auction begins, and may modify the ask price during the auction. In such two-sided auctions, the bidder may be matched with the item when the difference between the bid and the ask (e.g., the bid-ask spread) is greater than or equal to the particular counter value.

Due to the descending counter value described above, in auctions (both one-sided and two-sided) in which multiple items are available for bid, matches in which the declared willingness of the bidder and the receiver to pay relatively high prices for matches associated with an item are made earliest in the auction. Conversely, matches in which the declared willingness of the bidder and the receiver to pay relatively lower prices for matches associated with an item are made later in the auction. In some examples, the communication module 222 may be configured to provide each value of the plurality of counter values generated by the counter module 226 to each bidder of the plurality of bidders. Additionally, the communication module 222 may be configured to provide each value of the plurality of counter values to each receiver of the plurality of receivers. Such values may be provided, for example, electronically using the communication interface, 218 and via the network 112.

The matching module 228 may be configured to match the bidder and the item at least partly in response to a bid received by the communication module 222 from the bidder during the auction. For example, the matching module 228 may facilitate pairing the bidder with the particular receiver that provided the item for auction once the bidder and the receiver have agreed upon a price for the item using the series of descending counter values, and/or other rules of the auction. In any of the auctions described herein, the matching module 228 may match the bidder and the item based at least partly on a particular counter value of the series of counter values active when the bid is received, and the matching module 228 may also remove the bidder and the item from the auction based at least partly on the matching. In particular, the matching module 228 may remove the bidder and the receiver corresponding to the item from the auction based at least partly on matching the bidder and the item.

As noted above, in a one-sided descending price auction, the matching module 228 may be configured to automatically set the amount of a bid that is received from a bidder equal to the particular counter value that is active when the bid is received. In such examples, the matching module 228 may match the bidder and the item without receiving an ask from the receiver corresponding to the bid. In additional example one-sided auctions, the bidder may enter and/or modify a bid having an amount that is less than the particular counter value that is currently active. In such examples the matching module 228 may match the bidder and the item when the bid that is entered and/or modified by the bidder is greater than or equal to the particular counter value. In still further example one-sided auctions in which the receiver has entered a minimum ask or other such reserve price for the item before the auction begins, the matching module 228 may match the bidder and the item when the difference between the bid that is entered and/or modified by the bidder and the minimum ask or other such reserve price is greater than or equal to the particular counter value. Alternatively, in two-sided descending price auctions, the matching module 228 may be configured to determine a difference between a bid received from a bidder and an ask received from a receiver. For example, in a two-sided descending price auction, a bid received from a bidder may comprise a first amount proposed by the bidder for matching the bidder and the item. Additionally, an ask received from the receiver may comprise a second amount proposed by the receiver. The ask may be, for example, an amount that the receiver asks to be paid for the item and/or for matching the item and the bidder. In such examples, the matching module 228 may be configured to determine a difference (e.g., a bid-ask spread) between the first and second amounts. Additionally, in such examples, the bidder and the item may be matched by the matching module 228 at least partly in response to the difference being greater than or equal to the particular counter value that is active at the time the bid is received.

The payment module 230 may be configured to determine an amount that the bidder is responsible to provide to the receiver for the item, and/or an amount that the receiver is responsible to provide to the bidder as a condition of the bidder winning the auction. For example, at least partly in response to the matching module 228 matching a bidder with an item, the payment module 230 may be configured to determine whether the first amount described above is greater than the second amount. The payment module 230 may also be configured to determine an average of the first amount and the second amount. If this average is greater than zero, the payment module 230 may be configured to generate a payment request comprising a third amount equal to the average of the first and second amounts. In such examples, the communication module 222 may be configured to provide the payment request to the bidder provided that the average of the first and second amounts is greater than zero. Alternatively, if the average of the first and second amounts is less than zero, the payment module 230 may be configured to generate a payment request comprising a third amount equal to the negation of the average of the first and second amounts. In such examples, the communication module 222 may be configured to provide the payment request to the receiver provided that the average of the first and second amounts is less than zero. In still further examples, the bidder may be responsible for paying the bid amount to an auction service provider or other entity facilitating the auction. In yet another example, the bidder may be responsible for paying a portion of the third amount to an auction service provider or other entity facilitating the auction, and a remainder of the third amount to another participant. Additionally, as noted above, in any of the example auctions described herein, this third value may always be conveyed from the bidder to the receiver regardless of the relative amounts and/or signs of the bid and the ask. In such examples, the payment module may provide a payment request indicating the third amount to the bidder regardless of the relative amounts and/or signs of the bid and the ask. In example embodiments of the present disclosure, the payment module 230 may comprise any application, component, system, or component within a system, configured to facilitate payments between bidders and receivers participating in an auction. For example, the payment module 230 may be operable to outsource payment interactions between bidders and receivers. In such examples, the payment module 230 may connect, for example, a bank account of a bidder with a bank account of a receiver in order to facilitate the transfer of funds between the bank accounts. In other examples, the payment module 230 may connect the computing device 200 to an external payment service or other payment platform used by auction participants to facilitate payments.

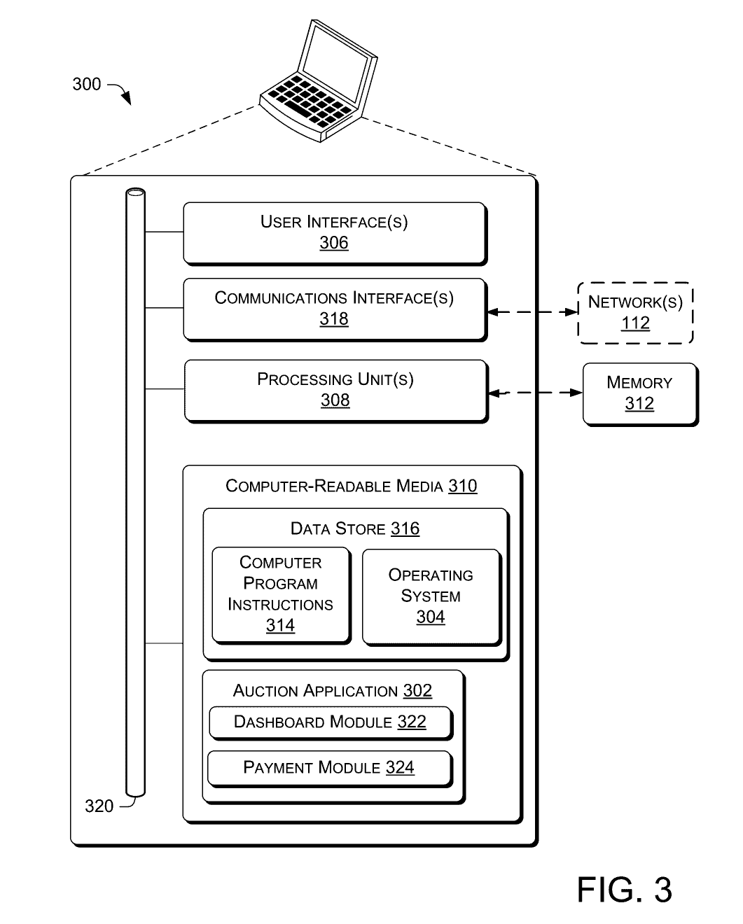

FIG. 3 is an illustrative diagram that shows example components of a user computing device 300, which can be similar to or the same as one or more of computing device(s) 102, 104, or 106, and which can be a computing device of a user 110 or 114. In particular, the user computing device 300 of FIG. 3 may comprise a computing device 106 of a bidder and/or a computing device 104 of a receiver used during an example auction of the present disclosure. In such examples, the user computing device 300 may be used by either a bidder or a receiver in a centralized auction in which one or more additional computing devices 200 (FIG. 2) operates and/or otherwise facilitates the auction between two or more entities according to various examples described herein. In particular, the system 100 of FIG. 1 may be configured to facilitate such a centralized auction and, as noted above with respect to FIG. 2, an auction service computing device 200 may implement an auction engine 202, an operating system 204, and/or any other software or hardware component configured to operate and/or otherwise facilitate such an auction. In some examples, the user computing device 300 of FIG. 3 may access a website or other interface of the auction via a browser. In other examples, the user computing device 300 may include an auction application 302 usable to interact with the auction engine 202 of the auction service computing device 200, an operating system 304, and/or any other software or hardware component configured to enable a bidder and/or a receiver to participate in such an auction.

User computing device 300 can include or be connected to a user interface 306, which can be similar to or the same as user interface 142. The user interface 306 can include various types of output devices and/or input devices described above with reference to user interface 142. The user interface 306 can also include one or more input/output (I/O) interfaces to allow user computing device 300 to communicate with input, output, or I/O devices. Examples of such devices can include components of user interface 306 such as user-operable input devices and output devices described above with reference to user interface 142.

The user computing device 300 can include one or more processing unit(s) 308, which can be similar to or the same as processing unit(s) 132. Processing units 308 can be operably coupled to the I/O interface and/or other user interface(s) 306, as well as to at least one computer-readable media 310, discussed below. Processing unit(s) 308 can include, e.g., processing unit types described above such as CPU- or GPGPU-type processing unit(s). In some examples, processing unit(s) 308 can include or be connected to a memory 312, e.g., a RAM or cache.

In some examples, computer-readable media 310 of the user computing device 300 can be similar to or the same as computer-readable media 134, and can store a plurality of modules of the auction application 302. The computer-readable media 310 can also store the operating system 304, and the operating system 304 may be similar in function and operation to the operating system 204 described above with respect to auction service computing device 200. Processing unit(s) 308 can be configured to execute modules of the plurality of modules of the auction application 302. For example, computer-executable instructions and/or other computer program instructions 314 stored within a data store 316 of the computer-readable media 310 can upon execution configure a computer such as a user computing device 300 to perform operations described herein with reference to the modules of the plurality of modules. The modules stored in the computer-readable media 310 can include instructions that, when executed by the one or more processing units 308, cause the one or more processing units 308 to perform operations described below.

In some examples, data store 316 can include data storage, structured or unstructured, such as a database (e.g., a Structured Query Language, SQL, or NoSQL database) or data warehouse. In some examples, data store 316 can include a corpus or a relational database with one or more tables, arrays, indices, stored procedures, and so forth to enable data access. Data store 316 can store data for the operations of processes, applications, components, or modules stored in computer-readable media 310 or computer instructions in those modules executed by processing unit(s) 308. In some examples, the computer program instructions 314 stored in the data store 316 may comprise instructions corresponding to processes described herein or to other software executable by processing unit(s) 308.

The user computing device 300 can also include a communications interface 318, which can be similar to or the same as communications interface 140. For example, communications interface 318 can include a transceiver device such as a network interface controller (NIC) to send and receive communications over the network 112 (shown in phantom), e.g., as discussed above. As such, the user computing device 300 can have network capabilities. For example, the user computing device 300 can exchange data with computing devices 102, 104, or 106 via one or more network(s) 112, and in some examples, the user computing device 300 can receive data from one or more data source(s) (not shown) via one or more network(s) 112.

In some examples, the processing unit(s) 308 can access the module(s) on the computer-readable media 310 via a bus 320, which can be similar to or the same as bus 136. User interface 306 and communications interface 318 can also communicate with processing unit(s) 308 via bus 320. The modules of the auction application 302 stored on computer-readable media 310 can include one or more modules (e.g., shell modules, or API modules) which are illustrated as a dashboard module 322 and a payment module 324. In the auction application 302, the number of modules can vary higher or lower, and modules of various types can be used in various combinations. For example, functionality described associated with the illustrated modules can be combined to be performed by a fewer number of modules or APIs or can be split and performed by a larger number of modules or APIs.

Example functionality associated with the modules 322 and 324 of the auction application 302 will be described in greater detail below with respect to example auctions. However, in some example systems of the present disclosure, such as systems including a user computing device 300 configured for use in a centralized auction facilitated by one or more central servers or other central computing device(s) 102, the dashboard module 322 may be configured to receive a bid for an item from a bidder of a plurality of bidders. The dashboard module 322 may also be configured to receive an ask from a receiver of a plurality of receivers during the auction. For example, such bids and asks may be received by the dashboard module 322 via the central computing device 102 facilitating the auction. The dashboard module 322 may also be configured to provide one or more dashboards or other user interfaces associated with the auction to the user 110, 114 of the user computing device 300 during the auction. Such user interfaces may be rendered via one or more of the displays or other user interfaces 306 described above.

In examples in which the user computing device 300 comprises a computing device of a receiver, the dashboard module 322 may generate a dashboard providing information useful to the receiver in generating an ask for a particular item. For example, such a dashboard may include the counter value that is currently active, a listing of each bidder participating in the auction, and information associated with each bidder. Such a dashboard may also include a search tool enabling the receiver to enter a search query via the dashboard, and providing results of the search query. Such a dashboard may also include one or more tools enabling the receiver to enter an ask price associated with matching a particular item with one or more of the bidders, change an ask price already entered by the receiver, request additional information regarding one or more of the bidders participating in the auction, send a message to one or more of the bidders, and/or other functionality useful to the receiver during an auction. It may also include bids made for that receiver's object(s) from various bidders.

Additionally, in examples in which the user computing device 300 comprises a computing device of a bidder, the dashboard module 322 may generate a dashboard providing information useful to the bidder in generating a bid for particular item. For example, such a dashboard may include the counter value that is currently active, a listing of each receiver providing an item for auction, and information associated with each item and/or each respective receiver. Such a dashboard may also include a search tool enabling the bidder to enter a search query via the dashboard, and providing results of the search query. Such search queries may enable the bidder to request information related to, for example, one or more receivers participating in the auction, past match prices for related items available in past auctions, other items available during the present auction, and/or any other information that may be useful to the bidder in placing and/or modifying a bid during the auction. Such a dashboard may further include one or more tools enabling the bidder to place a bid associated with matching the bidder with one or more items available via the auction, change a bid already entered by the bidder, request additional information regarding one or more of the receivers, and/or one or more of the items available via the auction, send a message to one or more of the receivers, and/or other functionality useful to the bidder during an auction. It may also, in some examples, include the asks of various receivers for their item from that bidder.

In some example systems of the present disclosure, such as systems including a user computing device 300 configured for use in a centralized auction facilitated by one or more central servers or other central computing device(s) 102, the payment module 324 may be configured to provide and/or facilitate providing electronic payment between the bidder and the receiver. In examples in which the user computing device 300 comprises a computing device of a bidder or receiver who receives payment as a result of the outcome of the auction, the payment module 324 may be configured to receive payment in the amount determined during the auction, and to route such payment to a bank account and/or other account of the bidder or receiver. Conversely, in examples in which the user computing device 300 comprises a computing device of a bidder or receiver who must make a payment as a result of the outcome of the auction, the payment module 324 may be configured to enable the bidder or receiver to provide payment in the amount determined during the auction, and to route such payment to a bank account and/or other account of the party receiving such payment. As noted above with respect to FIG. 2, such amounts may be determined by the payment module 230 of the auction service computing device 200. Further, as noted above, methods for determining such amounts may differ depending on whether the auction is a one-sided auction or a two-sided auction.

### Additional Illustrative Environment

As noted above, the example system 100 of FIG. 1 may comprise a system for use in a centralized auction. In such a centralized auction, one or more computing devices 102, 200 operate and/or otherwise facilitate the auction between two or more entities (e.g., a bidder and a receiver) according to various examples described herein. Additionally, one or more computing devices 104, 106, 300 may implement an auction application 302, an operating system 304, and/or any other software or hardware component configured to enable a bidder and/or a receiver to participate in such a centralized auction. It is understood that such a centralized auction may comprise either a one-sided auction or a two-sided auction.

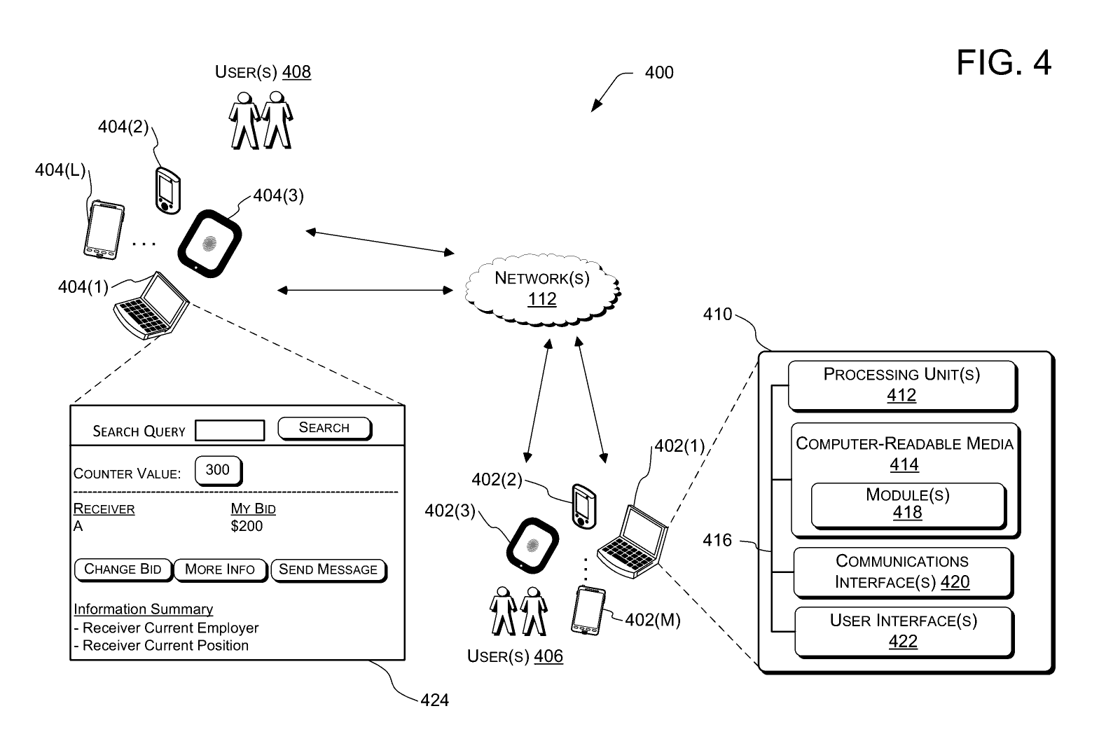

FIG. 4, on the other hand, illustrates an environment 400 comprising a system for use in a decentralized or “peer-to-peer” auction. In such a decentralized auction, the one or more computing devices 102, 200 described above with respect to FIGS. 1 and 2 may be omitted. Instead, one or more computing devices 402(1) . . . 402(M) (representing computing devices 104 and referred to singularly or collectively herein using reference 402) and/or one or more computing devices 404(1) . . . 404(L) (representing computing devices 106 and referred to singularly or collectively herein using reference 404) may operate and/or otherwise facilitate an auction between two or more entities (e.g., a bidder and a receiver) according to various examples described herein. For example, users 406 (e.g., receivers) may utilize a respective one of the computing devices 402 to enter an ask and/or otherwise participate in a decentralized one-sided or two-sided auction for an item provided by the respective receiver. Likewise, users 408 (e.g., bidders) may utilize a respective one of the computing devices 404 to enter a bid and/or otherwise participate in a decentralized one-sided or two-sided auction for an item provided by a receiver. In such examples, each of the computing devices 402, 404 may implement an auction application, an operating system, and/or any other software or hardware component configured to enable a bidder and/or a receiver to participate in such a decentralized auction.

Details of an example computing device 402(1) are illustrated at inset 410. The details of example computing device 402(1) can be representative of others of computing device(s) 402 or 404. However, each of the computing device(s) 402 can include additional or alternative hardware and/or software components. Computing device 402(1) can include one or more processing unit(s) 412 operably connected to one or more computer-readable media 414, e.g., via a bus 416. Some examples of processing unit(s) 412 are discussed above with reference to processing unit(s) 118. Some examples of computer-readable media 414 are discussed above with reference to computer-readable media 120. For example, computer-readable media 414 can include one or more computer storage media. Some examples of bus 416 are discussed above with reference to bus 122.

Computer-readable media 414 can store, for example, computer-executable instructions, an operating system, and/or other computer program instructions. The computer-readable media 414 can also store one or more module(s) 418 associated with an auction of the present disclosure, and/or other modules, programs, or applications that are loadable and executable by processing unit(s) 412. Some examples of modules 418 are discussed above with reference to modules 124 and 138.

Computing device 402 can also include one or more communications interfaces 420 connected via the bus 416 to processing unit(s) 412 to enable wired or wireless communications between computing device(s) 402 and other networked computing devices 402 or 404 involved in one or more auctions or other computing functions over network(s) 112. Some examples of communications interfaces 420 are discussed above with reference to communications interface(s) 126.

In some examples, computing device 402 can include a user interface 422 connected via the bus 416 to processing unit(s) 412. For example, computing device 402(1) can include a user interface 422 configured to enable a user 406 of the computing device 402 to control or otherwise interact with one or more of the computing devices 402, 404 via the network(s) 112. Some examples of user interfaces 422 are discussed above with reference to user interface 128.

The computing devices 404 can be similar to and/or the same as computing devices 402, and in some examples, the computing devices 404 can include one or more of the same components as described above with respect to the computing devices 402. Additionally, any of the computing devices 404, 406 described herein may be configured to provide one or more dashboards 424 or other user interfaces such as, via a display or other user interface of the computing device. As illustrated with respect to the computing device 404(1) of FIG. 4, an example dashboard 424 may provide a variety of information and functionality to a user 408 including, among other things, a search tool, a portion that provides a counter value to the user 408 in real time, information associated with, related to, and/or indicative of one or more auction participants, as well as one or more additional tools enabling the user 408 to, for example, enter and/or modify an ask, enter and/or modify a bid, request additional information from the auction service 108 and/or an auction participant, send a message to an auction participant, and/or perform one or more additional tasks associated with the auction. The dashboard 424 may be similar to and/or the same as the dashboard 144 described above. Additionally, an example dashboard 424 may be provided to, and may be tailored to, a bidder and/or a receiver during an auction.

### Additional Illustrative Components

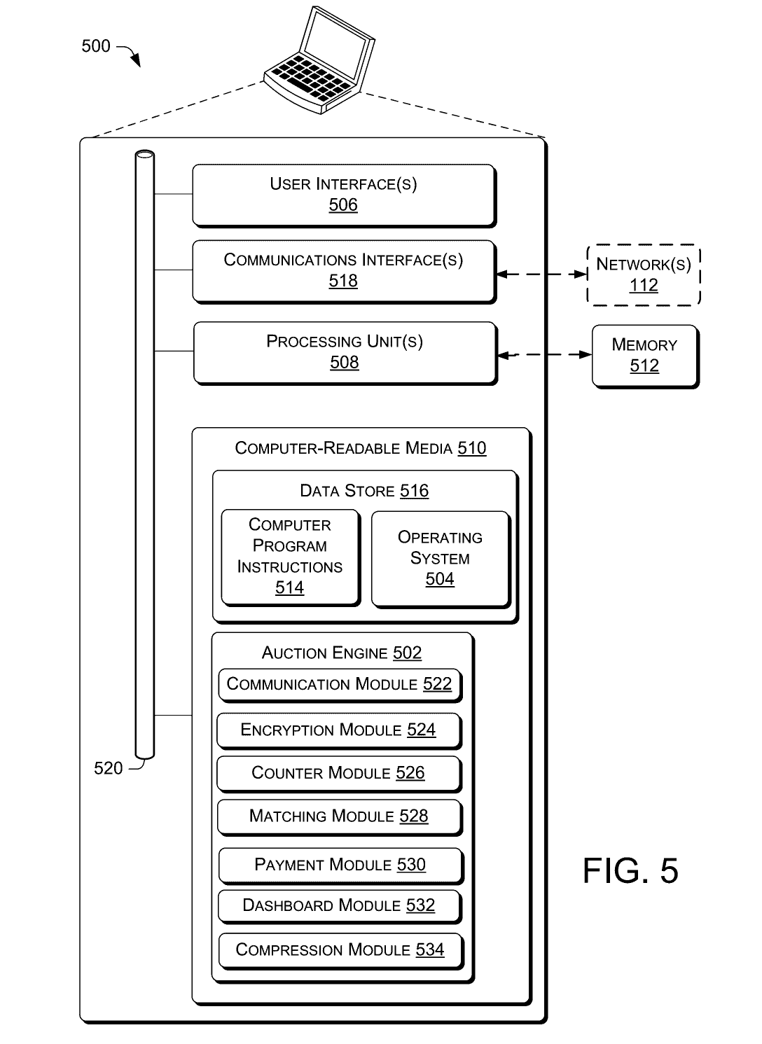

FIG. 5 is an illustrative diagram that shows example components of a computing device 500, which can be similar to or the same as one or more of computing device(s) 402 or 404, and which can be a computing device configured to operate and/or otherwise facilitate a decentralized one-sided or two-sided auction between two or more entities according to various examples described herein. Computing device 500 can implement an auction engine 502, an operating system 504, and/or any other software or hardware component configured to operate such an auction.

Computing device 500 can include or be connected to a user interface 506, which can be similar to or the same as user interface 422. The user interface 506 can include various types of output devices and/or input devices described above with reference to user interface 422. The user interface 506 can also include one or more input/output (I/O) interfaces to allow computing device 500 to communicate with input, output, or I/O devices. Examples of such devices can include components of user interface 506 such as user-operable input devices and output devices described above with reference to user interface 422.

The computing device 500 can include one or more processing unit(s) 508, which can be similar to or the same as processing unit(s) 412. Processing units 508 can be operably coupled to the I/O interface and/or other user interface(s) 506, as well as to at least one computer-readable media 510, discussed below. Processing unit(s) 508 can include, e.g., processing unit types described above such as CPU- or GPGPU-type processing unit(s). In some examples, processing unit(s) 508 can include or be connected to a memory 512, e.g., a RAM or cache.

In some examples, computer-readable media 510 of the computing device 500 can be similar to or the same as computer-readable media 414, and can store a plurality of modules of the auction engine 502. The computer-readable media 510 can also store the operating system 504, and the operating system 504 may be similar in function and operation to the operating system 304 described above with respect to user computing device 300. Processing unit(s) 508 can be configured to execute modules of the plurality of modules of the auction engine 502. For example, computer-executable instructions and/or other computer program instructions 514 stored within a data store 516 of the computer-readable media 510 can upon execution configure a computer such as a computing device 500 to perform operations described herein with reference to the modules of the plurality of modules. The modules stored in the computer-readable media 510 can include instructions that, when executed by the one or more processing units 508, cause the one or more processing units 508 to perform operations described below.

The computing device 500 can also include a communications interface 518, which can be similar to or the same as communications interface 420. For example, communications interface 518 can include a transceiver device such as a network interface controller (NIC) to send and receive communications over the network 112 (shown in phantom), e.g., as discussed above. As such, the computing device 500 can have network capabilities. For example, the computing device 500 can exchange data with computing devices 402 or 404 via one or more network(s) 112, and in some examples, the computing device 500 can receive data from one or more data source(s) (not shown) via one or more network(s) 112.

In some examples, the processing unit(s) 508 can access the module(s) on the computer-readable media 510 via a bus 520, which can be similar to or the same as bus 416. User interface 506 and communications interface 518 can also communicate with processing unit(s) 508 via bus 520. The modules of the auction engine 502 stored on computer-readable media 510 can include one or more modules (e.g., shell modules, or API modules) which are illustrated as a communication module 522, an encryption module 524, a counter module 526, a matching module 528, a payment module 530, a dashboard module 532, and a compression module 534. In the auction engine 502, the number of modules can vary higher or lower, and modules of various types can be used in various combinations. For example, functionality associated with the illustrated modules can be combined to be performed by a fewer number of modules or APIs or can be split and performed by a larger number of modules or APIs.

Example functionality associated with the modules 522, 524, 526, 528, 530, and 534 of the auction engine 502 will be described in greater detail below with respect to example auctions. Such functionality may be substantially similar to and/or the same as the functionality described above with the communication module 222, encryption module 224, counter module 226, matching module 228, payment module 230, and the compression module 232 of the auction service computing device 200 shown in FIG. 2. Additionally, the functionality of the dashboard module 532 may be substantially similar to and/or the same as the functionality described above with respect to the dashboard module 322 of the user computing device 300 shown in FIG. 3.

### Illustrative Processes

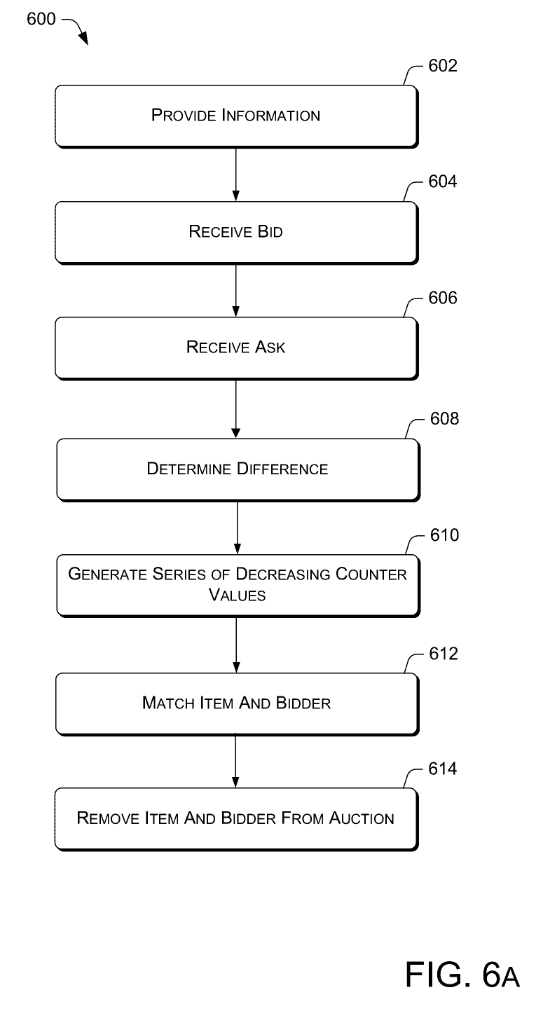

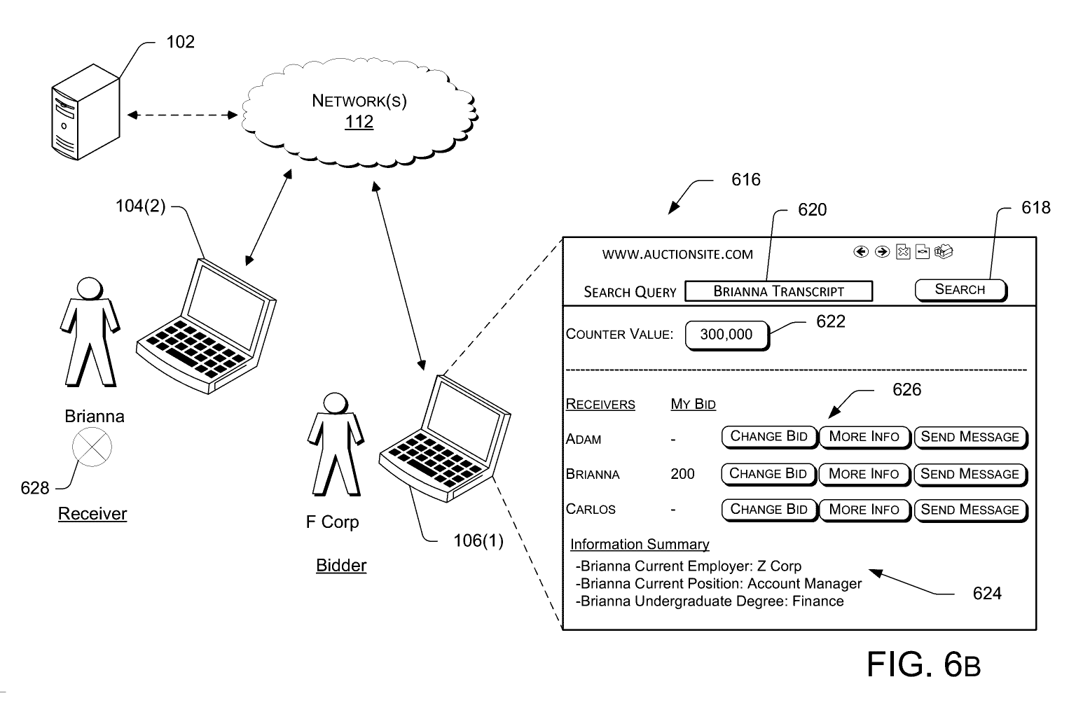

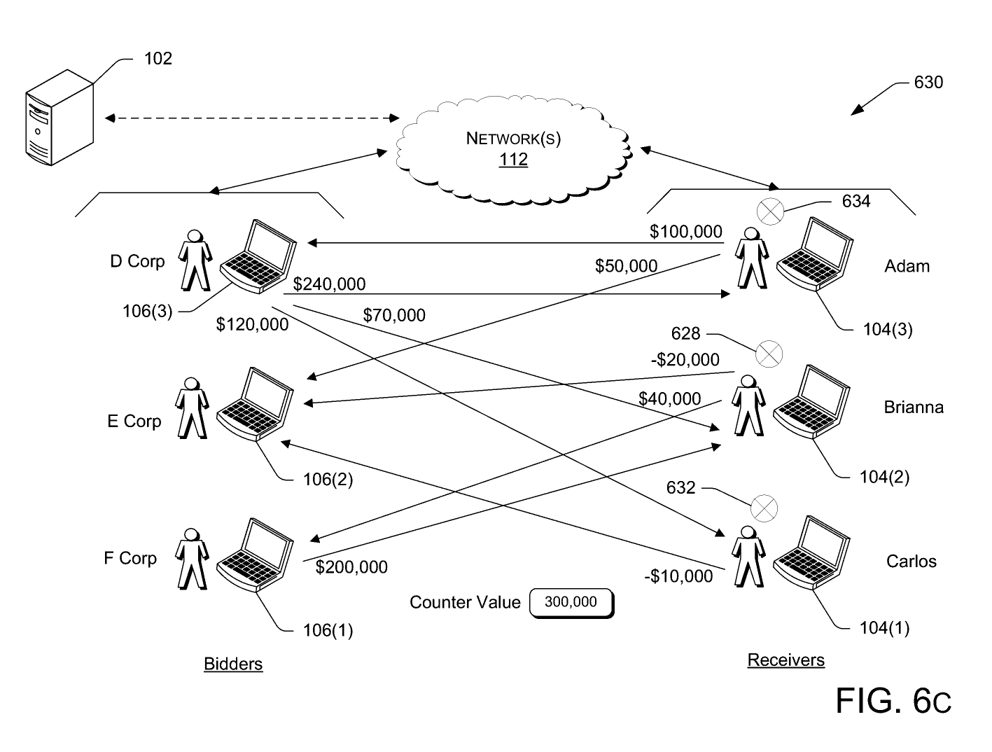

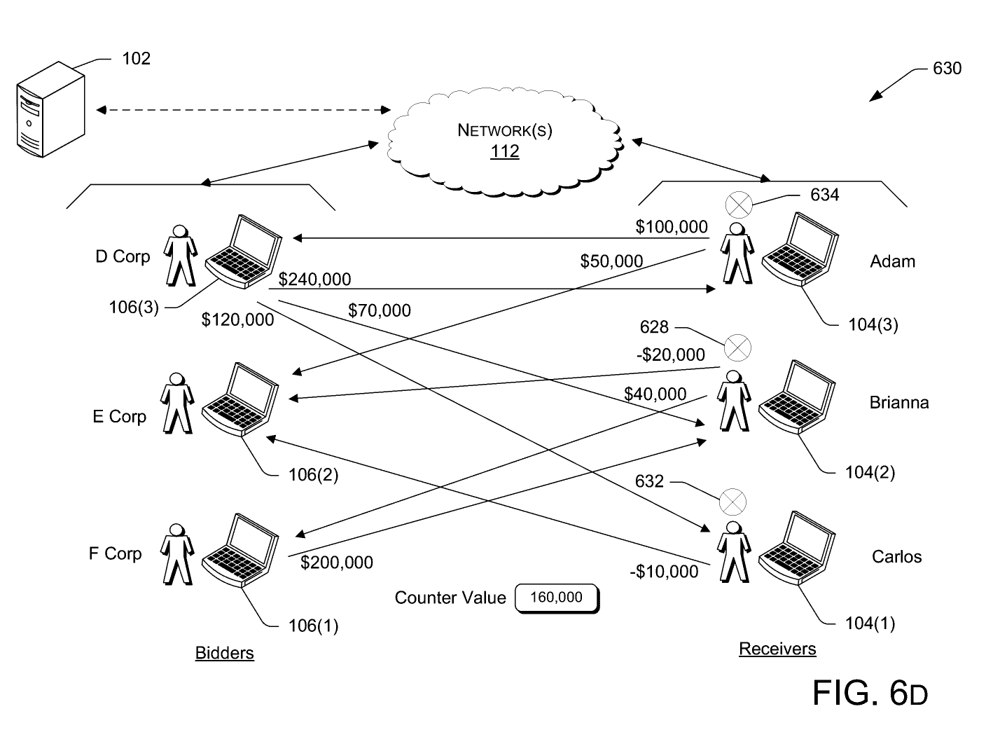

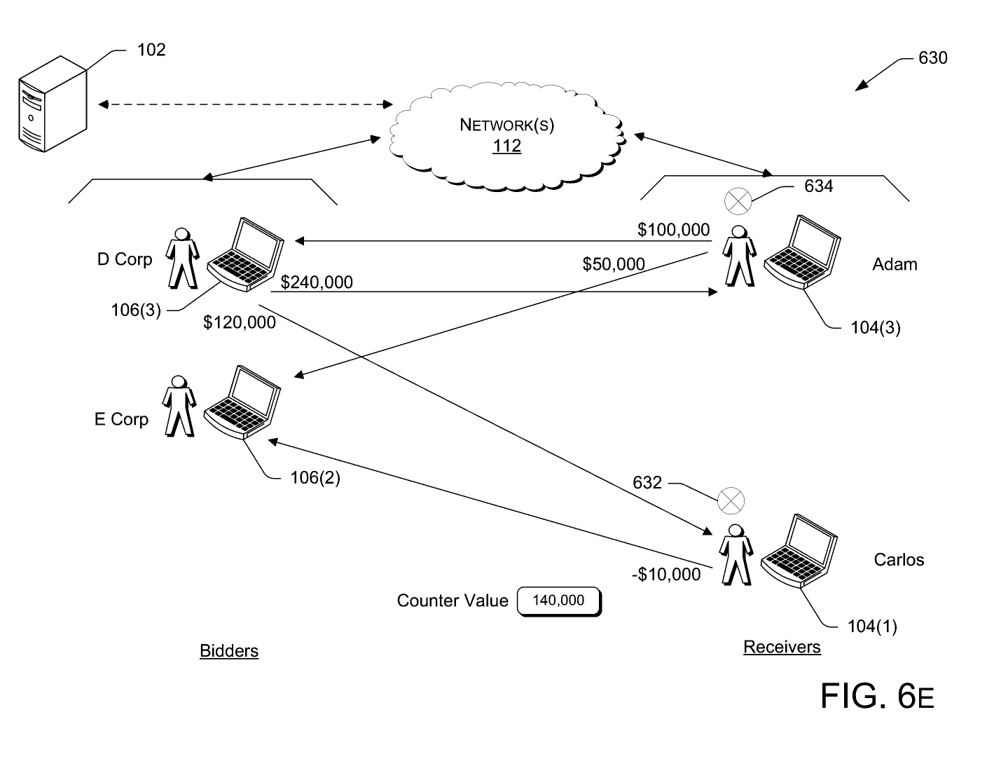

FIG. 6A is a flow diagram that illustrates an example method 600 for operating and/or otherwise facilitating a two-sided auction between two or more entities, such as between one or more bidders and one or more receivers. The example auction associated with the method 600 may comprise either a centralized auction or a decentralized auction. Accordingly, the auction associated with the method 600 may be performed, at least in part, using either the system illustrated in FIG. 1, and/or one or more components thereof, or the system illustrated in FIG. 4, and/or one or more components thereof. In particular, the example functions shown in FIG. 6A and other flow diagrams and example processes herein can be implemented on or otherwise embodied in one or more computing device(s) 102, 104, 106, 402, or 404, e.g., an auction service computing device 200, 300, or 500. For example, the functions shown in FIG. 6A and other flow diagrams and example processes herein can be implemented using software running on such device(s). In a centralized two-sided auction, such as an auction performed and/or facilitated by the system shown in environment 100, one or more of the functions of method 600 may be performed by one or more of the computing devices 102, 200. Alternatively, in a decentralized two-sided auction, such as an auction performed and/or facilitated by the system shown in environment 400, one or more of the functions of method 600 may be performed by one or more of the computing devices 402, 404, 500, and the computing devices 102, 200 may be omitted.

The order in which the operations are described in each example flow diagram or method is not intended to be construed as a limitation, and any number of the described operations can be combined in any order and/or in parallel to implement each method. Moreover, the operations in each of FIGS. 6A-6E can be implemented in hardware, software, and/or a combination thereof. In the context of software, the operations represent computer-executable instructions that, when executed by one or more processors, cause one or more processors to perform the recited operations. In the context of hardware, the operations represent logic functions implemented in circuitry, e.g., datapath-control and finite-state-machine sequencing functions.

In some examples, at block 602 one or more bidders wishing to participate in an auction may provide information associated with the bidder. For example, the one or more bidders may enter such information via the electronic device 300, 500. In some examples, the dashboard module 322 of the user computing device 300 may receive such information from a bidder, and the dashboard module 322 may provide such information to the communication module 222 of the auction service computing device 200. Alternatively, in a decentralized auction, the communication module 522 of the computing device 500 may receive such information from the bidder. Such information may include, for example, a name, address, date of birth, nationality, current employer, social security number, bank account number, telephone number, email address, names and contact information of references, a job description, a description of the job requirements, a location of the job, a proposed salary, a proposed title, and/or other information noted herein describing the bidder. Such information may be provided by the bidder in order to, for example, register for the auction.

Further, at block 602, one or more of the receivers wishing to provide an item for auction may also provide information. Such information may be associated with the receiver and/or with the item being provided by the receiver. For example, the one or more receivers may enter such information via a respective electronic device 300, 500 of the receiver. In some examples, the dashboard module 322 of the user computing device 300 may receive such information from a receiver, and the dashboard module 322 may provide such information to the communication module 222 of the auction service computing device 200. Alternatively, in a decentralized auction, the communication module 522 of the computing device 500 may receive such information from the receiver. Such information may include information describing an item provided for auction by the receiver. As noted above, such an item may be a the labor and/or services of the receiver, a house, an apartment, real estate, and/or any other tangible, digital, and/or intangible item, service, or other object that the receiver wishes to convey to a winning bidder via an auction. Accordingly, in examples in which the item comprises, for example, the services of the receiver, such information may include a resume and/or CV of the receiver, a list of employer references, a transcript of the receiver, a writing sample, and/or other information noted herein with respect to the receiver. In examples in which the item comprises a house, real estate, or other tangible object, the information may include a color, price, age, make, and/or model, of the object. Such information may also include any other information descriptive of the particular item provided for auction by the receiver.

At block 604, the method may include receiving a bid for the item from at least one bidder of a plurality of bidders participating in the auction. For example, the bidder may enter such a bid using the dashboard module 322 of the auction application 302 operable on the user computing device 300. The communications interface 318 may then provide the bid to the communication module 222 of the auction service computing device 200. Alternatively, in a decentralized auction the bidder may enter such a bid using the dashboard modules 532 operable on the computing device 500 being used by the bidder. At block 602, the bid may be received during the auction, and the bid may comprise a first amount proposed by the bidder for matching the bidder and the item.

At block 606, the method may also include receiving an ask from at least one receiver of a plurality of receivers participating in the auction. For example, the receiver may enter such an ask using the dashboard module 322 of the user computing device 300 being used by the receiver. The communication interface 318 may then provide the ask to the communications module 222 of the auction service computing device 200. Alternatively, in a decentralized auction the receiver may enter such an ask using the dashboard module 532 operable on the computing device 500 being used by the receiver. In the examples described herein, the ask may comprise a second amount proposed by the receiver for matching the item (provided by the receiver) and the bidder. For example, as noted above, the ask may comprise an amount that the receiver asks and/or wishes to be paid for the item provided by the receiver in the auction.

At block 608, the method may include determining a difference between the first and second amounts. It is understood that in some examples, one or both of the first amount and the second amount may have a negative value. For example, in auctions in which a bidder does not wish to be matched with an item provided by the receiver unless the bidder receives payment for being so matched, the bidder may submit a negative bid. In such examples, the difference determined at 608 may be calculated based on the sign (positive or negative) of the bid and the ask, respectively. It is understood, however, that typically, the bids received from bidders are positive. In some examples, such a difference may be determined by the matching module 228, and/or other modules of the auction engine 202 operable on the auction service computing device 200. Alternatively, in a decentralized auction such a difference may be determined by the matching module 528, and/or other modules of the auction engine 502 operable on the computing device 500 being utilized by either the bidder or the receiver.

At block 610, the method may include generating a series of decreasing counter values. Such counter values may comprise respective proxies for the strike price, matching price, and/or other price of the item during the auction. For example, during the auction the counter module 226 of the auction service computing device 200 may generate an initial counter value, and may continue to generate a series of counter values that decrease over time during the auction. Alternatively, in a decentralized auction the series of decreasing counter values may be generated by the counter module 526 of the computing device 500 of the bidder and/or the receiver at block 610.

In some examples, the counter values generated at block 610 may decrease at a substantially constant rate. Alternatively, the counter values generated at block 610 may decrease a variable rate. Such a rate may vary depending on the bid-ask spread associated with the various bids received by bidders participating in the auction and the various asks submitted by receivers participating in the auction. As noted above, the bid-ask spread may be determined by calculating a difference between the bid and the ask. For example, if the difference between a bid and an ask is equal to $200, and the particular counter value active when at least one of the bid and the ask is received is equal to $500, the counter values generated by the counter module 226, 526 may decrease at a relatively fast rate. However, as the counter value decreases such that it approaches the bid-ask spread of $200, counter module 226, 526 may decrease the rate at which the counter value decreases until the counter value is equal to the bid-ask spread. As noted above, a bidder participating in the auction may modify the bid, received at block 604, at any time during the auction. Additionally or alternatively, a receiver participating in the auction may modify the ask, received at block 606, at any time during the auction.

At block 612, the method may include matching a winning bidder and the item at least partially in response to the difference determined at block 608 being greater than or equal to a particular counter value of the series of counter values that is currently active, in real time. In some examples, the particular counter value may be the counter value that is active when the bid was received (e.g., at block 604). For example, during the auction the matching module 228 of the auction service computing device 200 may monitor the series of decreasing counter values generated by the counter module 226, and may compare such values to the various differences determined at block 608. Alternatively, in a decentralized auction the matching module 528 of the computing device 500 may monitor the series of decreasing counter values, and may compare such values to the differences determined at block 608. When the difference determined at block 608 is greater than or equal to the particular counter value described above, the matching module 228, 528 may pair, correlate, and/or otherwise match the bidder and the item. In some examples, such matching may include providing an electronic message or other notification to the winning bidder and to the receiver associated with the item.

At block 614, the method may further include removing the bidder and the item from the auction based at least partly on the matching described above with respect to block 612. For example, the matching module 228, 528 may cause the item and the bidder to no longer be visible to any of the other bidders and/or receivers participating in the auction. In such examples, the auction may continue until, for example, all the items provided by the various receivers have been matched with corresponding bidders. Alternatively, the auction may continue until, for example, all of the bidders have been matched with corresponding items or until, for example, the counter value reaches a predetermined threshold value such as zero. Blocks 602-614 will now be described in greater detail below with respect to FIGS. 6B-6E.

As shown in FIG. 6B, any of the information described above with respect to block 602 may be provided by the bidder or the receiver via a dashboard and/or other user interface operable on the respective computing device being utilized by the bidder or the receiver. Such information may be provided before and/or during the auction. For example, a bidder, F Corp, may provide information at block 602 via a dashboard 616 generated, and/or otherwise provided by the dashboard module 322 of a computing device 106(1) utilized by one or more users associated with F Corp. Alternatively, in a decentralized auction F Corp and/or any of the other bidders may provide such information at block 602 via a substantially identical dashboard 616 generated, and/or otherwise provided by the dashboard module 532 of a computing device 404(1) utilized by one or more users 408 associated with F Corp. In any of the example embodiments described herein, such a dashboard 616 may include a variety of tools operable to enable the user to provide information, request information, view information, and/or perform one or more additional functions associated with the auction. For example, the dashboard 616 may include a search tool 618 and a query box 620. In such examples, a user may enter text or other information into the query box 620, and the search tool 618 may generate one or more web-based searches corresponding to such information. In some examples, the search tool 618 may comprise one or more search engines, and/or other search applications. The dashboard 616 may also include a portion 622 at which the counter value described above is provided to the user. For example, the portion 622 may comprise one or more icons, windows, and/or other dashboard components at which the counter value may be provided to the user. As described above, the series of decreasing counter values may be accessible by each bidder of a plurality of bidders during an auction. In additional examples, the series of decreasing counter values may also be accessible by each receiver of a plurality of receivers, during an auction. In such examples, the counter values may be provided to one or more of the bidders and/or to one or more of the receivers via the portion 622 of the dashboard 616.

The dashboard 616 may also provide a plurality of information 624 to the user. For example, such information 624 may include, among other things, the current employer, the current position, the undergraduate degree, the graduate degree, the length of current employment, the name, age, nationality, residence, and/or other information associated with one or more receivers participating in the auction, the amount of one or more previously successful bids associated with a particular item provided by the receiver for auction, a description of the item, a location of the item, and original cost of the item, and/or other corresponding items available in the auction. Any such information may have been provided by the receivers at step 602 and/or may be a result of one or more search queries performed by the search tool 618. Such information 624 may also include the current bid provided by the bidder for each respective item available in the auction. Further, in examples in which the dashboard 616 is provided to one or more receivers participating in the auction, such information 624 may include, any of the information described above as being provided by example receivers during step 602. The dashboard 616 may also provide one or more additional tools 626. In examples in which the dashboard 616 is provided to one or more receivers, such additional tools 626 may enable the receiver to place and/or change an ask associated with one or more of the bidders, to request additional information from one or more of the bidders, to send a message to one or more of the bidders, and/or to perform any other additional tasks associated with the auction. Alternatively, in examples in which the dashboard 616 is provided to one or more bidders participating in the auction, as shown in FIG. 6B, such additional tools 626 may enable the bidder to place and/or change a bid associated with one or more of the receivers, and/or an item 628 provided by the one or more receivers, to request additional information from one or more of the receivers associated with the receiver and/or the item 628, to send a message to one or more of the receivers, and/or to perform any other additional tasks associated with the auction.

For example, in any of the methods described herein, the receiver may receive an information request associated with an item 628, provided by the receiver during the auction, from at least one bidder of a plurality of bidders during the auction. Such an information request may be entered by the bidder via one or more tools provided in the dashboard 616, and the receiver may receive such a request via a corresponding dashboard 616 generated by the computing device 104(2). In particular, such an information request may be received by the computing device 104(2) being used by the receiver during the auction and/or by the auction service computing device 200. Alternatively, in a decentralized auction, such information may be received by the computing device 500. At least partly in response to receiving the information request, the receiver may provide information associated with the item 628 to the at least one bidder prior to receipt of the bid at block 604. For example, the receiver may enter a response to the request via a dashboard 616 generated by the computing device 104(2), and may provide such a response using one or more of the tools 626 included in the dashboard 616. In particular, the information associated with the item 628 may be provided to the computing device 106(1) being utilized by the bidder by the auction service computing device 200. Alternatively, in a decentralized auction, such information may be provided directly to the computing device 106(1) of the bidder by the computing device 104(2) of the receiver. It is understood that any of the functionality described herein with respect to the various dashboards 616 generated by computing devices of the bidders and of the receivers, may be provided by the dashboard module 322, and/or other modules of the respective computing devices of the bidders and of the receivers. Alternatively, in a decentralized auction, the functionality described herein with respect to the various dashboards 616 may be provided by the dashboard module 532 and/or other modules of the respective computing devices of the bidders and of the receivers.

Additionally, in any of the methods described herein, one or more encryption modules of the present disclosure may be configured to generate encrypted information by encrypting information received from at least one of the bidder, the receiver, and the auction service. The encryption module may also store encrypted information within the computer-readable media and/or other memory of the electronic device on which the encryption module is operable. For example, any of the information provided at block 602, one or more of the bids received at block 604, and/or one or more of the asks received at block 606 may be encrypted by the encryption module 224 of the computing device 102 upon receipt thereof. Such a computing device 102 may be in communication with the computing device 104(2) of the receiver and with the computing device 106(1) of the bidder. Alternatively, in a decentralized auction such information may be encrypted by the encryption module 524. By encrypting information in this way, the encryption modules 224, 524 described herein may provide increased security with respect to information that is shared during the auction. Additionally, in any of the auctions described herein, the encryption modules 224, 524 and/or the compression modules 232, 534 may modify the various information, messages, requests, bids, asks, and/or other auction content described herein prior to transmitting such content using via the network 112. For example, the compression modules 232, 534 may compress, zip, and/or otherwise modify such auction content, thereby generating modified auction content prior to transmission. Such modified auction content may have a reduced size, reduced bandwidth requirements, reduced memory requirement, and/or other such characteristic. As a result, such modified auction content may be transmitted across the network 112 more quickly, may reduce the bandwidth and/or other system resources required for transmission, and may reduce the memory requirements at one or more of the computing devices 200, 102, 104, 106 associated with storing such content. As a result, generation and utilization of such modified auction content by the encryption modules 224, 524 and/or the compression modules 232, 534 may improve the efficiency of the systems described herein, and/or of the auction facilitated by such systems.

FIG. 6C illustrates part of an example two-sided auction 630 of the present disclosure. As shown in FIG. 6C, the example receivers Brianna, Carlos, and Adam may each provide respective items 628, 632, 634 for the auction 630. Additionally, the receivers may provide an ask associated with one or more of the bidders participating in the auction. As noted above, each ask may comprise an amount proposed by the receiver for matching the item associated with the respective receiver and a corresponding bidder. Such asks may be positive or negative, as noted above. It is understood that in typical auctions, such asks comprise positive values indicating the amount that the receiver asks to be paid for the item provided by that respective receiver. It is also understood that for a given item, a receiver may provide different asks for respective bidders participating in the auction. As shown in FIG. 6C, the example bidders F Corp, E Corp, and D Corp may each provide a bid associated with one or more of the receivers and/or with the one or more of the items 628, 632, 634. In particular, each bid provided by a bidder may comprise an amount proposed by the bidder for matching the respective bidder and the corresponding item. With reference to, for example, F Corp and Brianna, it is understood that F Corp has provided a bid of $200,000 associated with matching with Brianna and the item 628. In the present example, the item 628 may comprise labor and services offered by Brianna, such as for one or more job openings, and F Corp may comprise one of a plurality of bidders participating in the auction and bidding on Brianna's services. F Corp has not provided bids associated with any of the additional receivers participating in the auction 630. Additionally, it is understood that Brianna has provided an ask of $40,000 associated with matching the item 628 (e.g., her services) with F Corp. Brianna has also provided an ask of −$20,000 associated with matching the item 628 with E Corp.

During such an auction 630, the counter value generated by the counter module 226, 526 may be accessible by each of the bidders and/or by each of the receivers, such as via the respective computing devices 106, 104 utilized, thereby. Additionally, in any of the methods described herein, one of the receivers may receive at least one of a modification to a bid provided by a bidder and a message from the bidder. In such examples, the modification and/or the message may be received, for example, by the communication module 222, and/or other modules of the computing device 102, and the computing device 102 may provide the modification and/or the message to the computing device 104 of the appropriate receiver via the network 112. Alternatively, in a decentralized auction, the modification and/or the message may be received directly by the communication module 522 of the computing device 104 utilized by the receiver. Similarly, in any of the two-sided auctions described herein, the receiver may submit a modification to one or more asks at any time during the auction. Such modifications may be received by, for example, the communication module 222, and/or other modules of the computing device 102, and the computing device 102 may provide the modification to the computing device 106 of the appropriate bidder via the network 112. Alternatively, in a decentralized auction, the modification may be received directly by the communication module 522 of the computing device 106 utilized by the bidder.

FIG. 6D illustrates another part of the example two-sided auction 630. As shown in FIG. 6D, the example auction 630 has progressed and the series of counter values have decreased such that the particular counter value currently active is equal to 160,000. At this stage of the auction 630, the difference between the bid provided by F Corp ($200,000) and the ask provided by Brianna ($40,000) (e.g., the bid-ask spread) is greater than or equal to the particular counter value (160,000) that is currently active. Accordingly, at this stage of the auction the matching module 228 of the computing device 102 may remove the item 628 and Brianna from the auction 630. Additionally, and/or, alternatively, the matching module 228 may remove F Corp from the auction 630. Further, it is understood that in a decentralized auction the matching module 528 operable on the computing devices 106(1), 104(2) may remove the item 628, F Corp, and Brianna from the auction 630. FIG. 6E illustrates a further part of the example two-sided auction 630 in which the item 628, F Corp, and Brianna have been removed.

As shown in FIG. 6E, Adam, Carlos, D Corp, and E Corp may remain in the auction 630 until future matches are made in accordance with the methods described herein. For example, the active counter value may continue to decrease until an additional difference between a respective bid and a corresponding ask is greater than or equal to the counter value. Additionally, as part of any of the methods described herein, once a match has been made one or more of the computing devices may determine an amount required for the bidder to pay to the receiver for the item, or vice versa. Additionally, such methods may include providing a payment request to the bidder and/or the receiver. For example, once F Corp has been matched with the item 628, the payment module 230 of the computing device 102 may determine an average of the first amount of the bid provided by F Corp ($200,000) and the second amount of the ask provided by Brianna ($40,000), and may generate a payment request that includes a third amount equal to the average of the first and second amounts. For example, the payment module 230 may determine that the average of the first and second amounts described above (e.g., ($200,000+$40,000)/2) equals $120,000. In such a method, the payment module 230 may generate a payment request comprising a third amount equal to $120,000 (e.g., the average of the first amount and the second amount). The payment module 230 may provide such a payment request to the bidder using, for example, communication module 222. In particular, the communication module 222 of the computing device 102 may send such a payment request to the computing device 106(1) being utilized by F Corp, and the payment module 324 of the computing device 106(1) may assist F Corp in providing a corresponding payment to Brianna, such as by an electronic fund transfer, an electronic check, and/or any other form of electronic payment. Alternatively, in a decentralized auction one or more of the methods described above with respect to, for example, determining an average between the first and second amounts, generating a payment request comprising a third amount equal to the average, and/or providing a payment request may be performed by the payment module 530, communication module 522, and/or other modules operable on at least one of the computing devices 106(1) and 104(2).

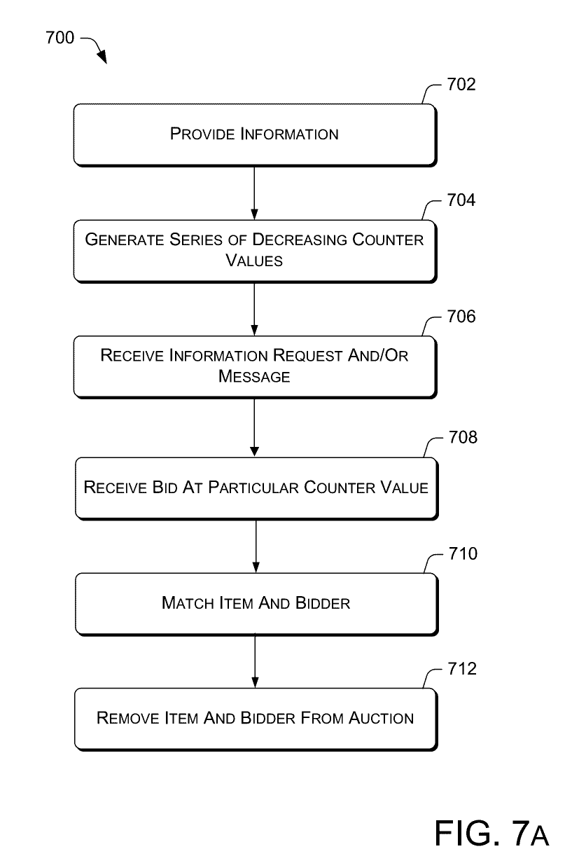

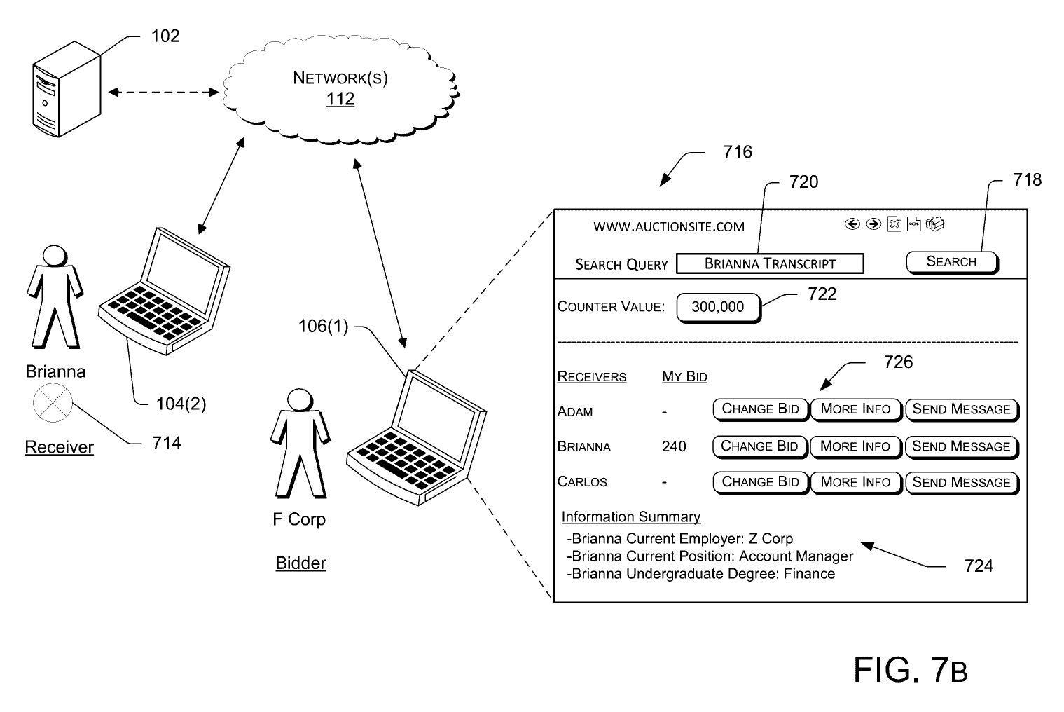

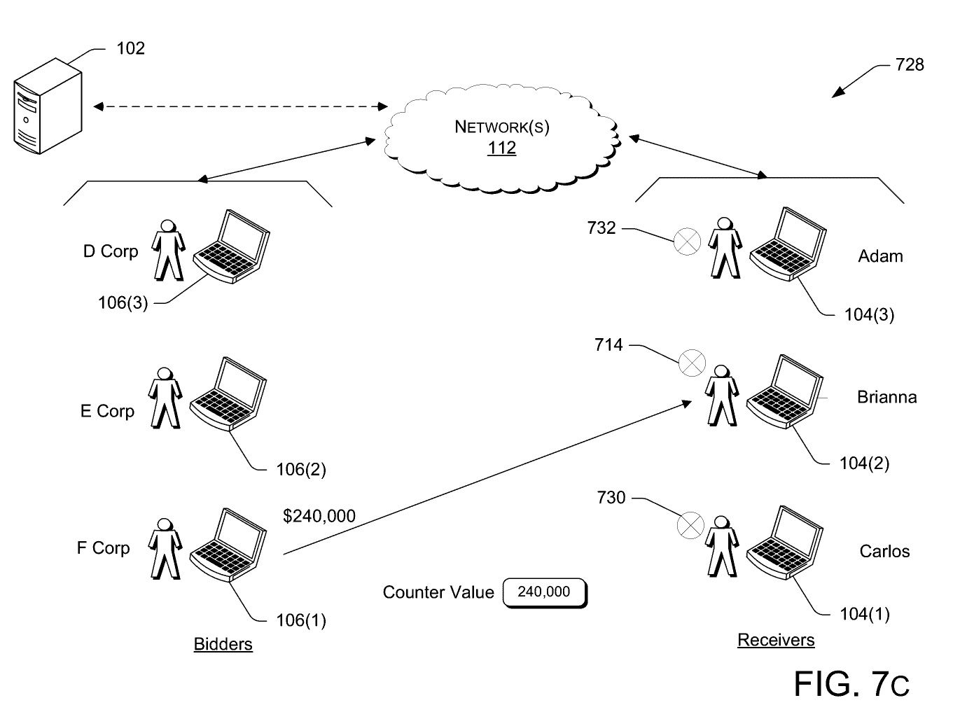

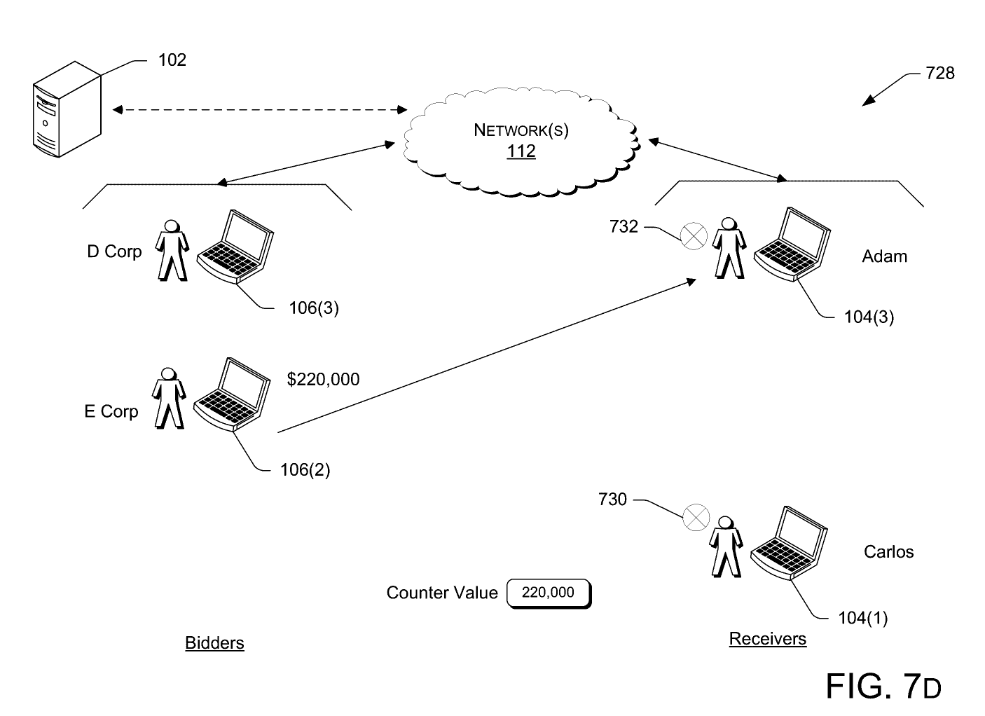

FIG. 7A is a flow diagram that illustrates an example method 700 for operating and/or otherwise facilitating a one-sided auction between two or more entities, such as between one or more bidders and one or more receivers. The example auction associated with the method 700 may comprise either a centralized auction or a decentralized auction. Accordingly, the auction associated with the method 700 may be performed, at least in part, using either the system illustrated in FIG. 1, and/or one or more components thereof, or the system illustrated in FIG. 4, and/or one or more components thereof. In particular, the example functions shown in FIG. 7A and other flow diagrams, and example processes herein, can be implemented on or otherwise embodied in one or more computing device(s) 102, 104, 106, 402, or 404, e.g., an auction service computing device 200, 300, or 500. For example, the functions shown in FIG. 7A and other flow diagrams and example processes herein can be implemented using software running on such device(s). In a centralized one-sided auction, such as an auction performed and/or facilitated by the system shown in environment 100, one or more of the functions of method 700 may be performed by one or more of the computing devices 102, 200. Alternatively, in a decentralized one-sided auction, such as an auction performed and/or facilitated by the system shown in environment 400, one or more of the functions of method 700 may be performed by one or more of the computing devices 402, 404, 500, and the computing devices 102, 200 may be omitted. In example one-sided auctions of the present disclosure, and as will be described with respect to FIGS. 7A-7D, the receivers may be passive participants in the auction once the auction begins.

The order in which the operations are described with respect to FIGS. 7A-7D is not intended to be construed as a limitation, and any number of the described operations can be combined in any order and/or in parallel to implement each method. Moreover, the operations in each of FIGS. 7A-7D can be implemented in hardware, software, and/or a combination thereof. In the context of software, the operations represent computer-executable instructions that, when executed by one or more processors, cause one or more processors to perform the recited operations. In the context of hardware, the operations represent logic functions implemented in circuitry, e.g., datapath-control and finite-state-machine sequencing functions.

In some examples, at block 702 one or more of the bidders wishing to participate in the auction may provide information associated with the bidder. For example, the one or more bidders may enter such information via the electronic device 300, 500. In some examples, the dashboard module 322 of the user computing device 300 may receive such information from a bidder, and the dashboard module 322 may provide such information to the communication module 222 of the auction service computing device 200. Alternatively, in a decentralized auction, the communication module 522 of the computing device 500 may receive such information from the bidder. Such information may include a name, address, date of birth, nationality, current employer, social security number, bank account number, telephone number, email address, job description, benefits, location of work proposed and/or other information describing the bidder. Such information may be provided by the bidder in order to, for example, register for the auction. Such information may be substantially similar to and/or the same as the information described above with respect to FIGS. 6A-6E.

Further, at block 702, one or more of the receivers wishing to provide an item for auction may also provide information. Such information may be associated with the receiver and/or with the item being provided by the receiver. For example, the one or more receivers may enter such information via a respective electronic device 300, 500 of the receiver. In some examples, the dashboard module 322 of the user computing device 300 may receive such information from a receiver, and the dashboard module 322 may provide such information to the communication module 222 of the auction service computing device 200. Alternatively, in a decentralized auction, the communication module 522 of the computing device 500 may receive such information from the receiver. Such information may include information describing an item provided for auction by the receiver. Such items, and the information provided, may be substantially similar to and/or the same as those described above with respect to FIGS. 6A-6E.

At block 704, the method may include generating a series of decreasing counter values. Such counter values may comprise respective proxies for the strike price, matching price, and/or other price of the item during the auction. For example, during the auction the counter module 226 of the auction service computing device 200 may generate an initial counter value, and may continue to generate a series of counter values that decrease over time during the auction. Alternatively, in a decentralized one-sided auction the series of decreasing counter values may be generated by the counter module 526 of the computing device 500 of the bidder. In some examples, the counter values generated at block 704 may decrease at a substantially constant rate. Alternatively, the counter values generated at block 704 may decrease at a variable rate. Such a rate may vary depending on the spread between, for example, the various bids received by bidders participating in the auction and various reserve prices or other parameters set by one or more of the receivers before the auction began. Such bid-ask spreads and/or variable rates may be determined in accordance with the processes described above with respect to FIG. 6A.

At block 706, the method may include receiving an information request associated with the item being auctioned and/or a message from at least one bidder of a plurality of bidders during the auction. Such an information request or message may be received by the communication module 222 of the auction service computing device 200, and the communication module 222 may provide the request and/or the message to the user computing device 300 of the receiver. Alternatively, in a decentralized one-sided auction, the information request or message may be directly received by the user computing device 300 of the receiver.

At block 708, the method may include receiving a bid for the item from at least one bidder of a plurality of bidders participating in the auction. For example, the bidder may enter such a bid using the dashboard module 322 of the auction application 302 operable on the user computing device 300. The communications interface 318 may then provide the bid to the communication module 222 of the auction service computing device 200. Alternatively, in a decentralized auction the bidder may enter such a bid using the dashboard modules 532 operable on the computing device 500 being used by the bidder. At block 708, the bid may be received during the auction. Additionally, as described above, the auction may be governed by the series of decreasing counter values that are generated at block 704. Thus, in a one-sided auction, the bid received from the bidder may comprise a particular counter value of the series of counter values that is active when the bid is received. The bid may comprise an amount proposed by the bidder for matching the bidder and the item. Alternatively, as described above, in such one-sided auctions the bidder may enter and/or modify a bid having an amount that is less than the particular counter value that is currently active.

At block 710, the method may include matching a winning bidder and the item at least partially in response to receiving the bid. For example, during a one-sided auction the matching module 228 may match the bidder and the item once a bid for the item is received by the auction service computing device 200. In some examples, the bid received must be greater than or equal to a minimum reserve price set by the receiver corresponding to the item, as described above. In any of the example one-sided auctions described herein the matching module 228 of the auction service computing device 200 may monitor the series of decreasing counter values generated by the counter module 226, and may compare such values to the various bids received at block 708. Alternatively, in a decentralized auction the matching module 528 of the computing device 500 may monitor the series of decreasing counter values, and may compare such values to the bids received at block 708. When a bid is received for an item that is greater than or equal to a minimum reserve price set by the receiver corresponding to the item and is also greater than or equal to the particular counter value of the series of counter values that is currently active, the matching module 228, 528 may pair, correlate, and/or otherwise match the bidder and the item. In some examples, such matching may include providing an electronic message or other notification to the winning bidder and to the receiver associated with the item. Additionally, in example one-sided auctions in which the receiver has set a reserve price for the item being auctioned, the matching modules 228, 528 may match the bidder and the item when the difference between the bid that is entered and/or modified by the bidder and the reserve price set by the receiver is greater than or equal to the particular counter value.

At block 712, the method may further include removing the bidder and the item from the auction based at least partly on the matching described above with respect to block 710. For example, the matching module 228, 528 may cause the item and the bidder to no longer be visible to any of the other bidders and/or receivers participating in the auction. In such examples, the auction may continue until, for example, all the items provided by the various receivers have been matched with corresponding bidders. Alternatively, the auction may continue until, for example, all of the bidders have been matched with corresponding items. Blocks 702-712 will now be described in greater detail below with respect to FIGS. 7B-7D.

It is understood that any of the information described above with respect to block 702, such as information associated with an item 714 provided for auction by a receiver, may be provided by the bidder or the receiver via a dashboard and/or other user interface operable on the respective computing device being utilized by the bidder or the receiver. Such information may be provided before and/or during the auction. For example, a receiver, Brianna, may provide information at block 702 via a dashboard generated, and/or otherwise provided by the dashboard module 322 of a computing device 104(2) utilized by the receiver. Alternatively, in a decentralized auction the receiver may provide such information at block 702 via a substantially identical dashboard generated, and/or otherwise provided by the dashboard module 532 of a computing device 402(1) utilized by the receiver. Further, as shown in FIG. 7B, such a dashboard 716 may also be provided to an example bidder, F Corp before and/or during the auction. The dashboards described herein with respect to FIG. 7B may be substantially similar to and/or the same as the dashboards described above with respect to at least FIG. 6B.

In any of the example embodiments described herein, such a dashboard 716 may include a variety of tools operable to enable the user to provide information, request information, view information, and/or perform one or more additional functions associated with the auction and/or the item 714 provided by the receiver. For example, the dashboard 716 may include a search tool 718 and a query box 720. In such examples, a user may enter text or other information into the query box 720, and the search tool 718 may generate one or more web-based searches corresponding to such information. The dashboard 716 may also include a portion 722 at which the counter value described above is provided to the user. As described above, the series of decreasing counter values may be accessible by each bidder of a plurality of bidders during an auction. In such examples, the counter values may be provided to one or more of the bidders via the portion 722 of the dashboard 716.

The dashboard 716 may also provide a plurality of information 724 to the user. As shown in FIG. 7B, in examples in which the dashboard 716 is provided to one or more bidders participating in the auction, such information 724 may include, among other things, any of the information described above with respect to the dashboard 616. The dashboard 716 may also provide one or more additional tools 726. In examples in which the dashboard 716 is provided to one or more bidders participating in a one-sided auction, such additional tools 726 may enable the bidder to place and/or change a bid associated with one or more of the receivers, and/or the item 714 provided by the one or more receivers, to request additional information from one or more of the receivers associated with the receiver and/or the item 714, to send a message to one or more of the receivers, and/or to perform any other additional tasks associated with the auction.

As noted above with respect to block 706, in any of the methods described herein, the receiver may receive an information request associated with an item 714 provided by the receiver, from at least one bidder of a plurality of bidders, during the auction. Such an information request may be entered by the bidder via one or more tools provided in the dashboard 716, and the receiver may receive such a request via a corresponding dashboard generated by the computing device 106(1). In particular, such an information request may be received by the computing device 104(2) being used by the receiver during the auction and/or by the auction service computing device 200. Alternatively, in a decentralized auction, such information may be received by the computing device 500. At least partly in response to receiving the information request, the receiver may provide information associated with the item 714 to the at least one bidder prior to receipt of the bid at block 708. For example, the receiver may enter a response to the request via a dashboard generated by the computing device 104(2), and may provide the response, including the information associated with the item 714, to the bidder prior to receipt of the bid at block 708. In particular, the information associated with the item 714 may be provided to the computing device 106(1) being utilized by the bidder via the auction service computing device 200. Alternatively, in a decentralized one-sided auction, such information may be provided directly to the computing device 106(1) of the bidder by the computing device 104(2) of the receiver. It is understood that any of the functionality described herein with respect to the various dashboards 716 generated by computing devices of the bidders and of the receivers, may be provided by the dashboard module 322, and/or other modules of the respective computing devices of the bidders and of the receivers. Alternatively, in a decentralized auction, the functionality described herein with respect to the various dashboards 716 may be provided by the dashboard module 532 and/or other modules of the respective computing devices of the bidders and of the receivers.

Additionally, in any of the methods described herein, one or more encryption modules of the present disclosure may be configured to generate encrypted information by encrypting information received from at least one of the bidder, the receiver, and the auction service. The encryption module may also store encrypted information within the computer-readable media and/or other memory of the electronic device on which the encryption module is operable. For example, any of the information provided at block 702, one or more of the bids received at block 708, and/or any other information associated with the one-sided auctions or two-sided auctions described herein may be encrypted by the encryption module 224 of the computing device 102 upon receipt thereof. Such a computing device 102 may be in communication with the computing device 106(1) of the bidder and with the computing device 104(2) of the receiver. Alternatively, in a decentralized auction such information may be encrypted by the encryption module 524. Any of the encryption processes described above with respect to FIGS. 6A-6E may be performed during the example methods associated with FIGS. 7A-7D. Additionally, in any of the methods described herein, the various received bids and/or asks may include a respective encryption key. Accordingly, in such methods the various encryption modules of the present disclosure may authenticate the encryption key and verify an identity of the bidder and/or receiver based at least in part on the authenticating of the systems described herein, and/or of the auction facilitated by such systems. Further, any of the compression and/or other processes described above with respect to at least the compression modules 232, 534 may be performed during the example methods associated with FIGS. 7A-7D.

FIG. 7C illustrates part of an example one-sided auction 728 of the present disclosure. As shown in FIG. 7C, the example receivers, Brianna, Carlos, and Adam may each provide respective items 714, 730, 732 for the auction 728. Additionally, although not shown in FIG. 7C, one or more of the receivers may also provide a minimum reserve price associated with the respective items 714, 730, 732. As shown in FIG. 7C, one of the bidders, such as F Corp, may provide a bid associated with one or more of the items 714, 730, 732 provided by the receivers at a particular counter value. In particular, when the decreasing counter value reaches an amount agreeable to F Corp, F Corp may enter a bid associated with one or more of the items 714, 730, 732. The bid entered by F Corp may be, for example, less than or equal to the counter value that is currently active in the auction 728. In the example illustrated in FIG. 7C, the bid entered by F Corp may be less than or equal to $240,000. During such an auction 728, the counter value generated by the counter module 226, 526 may be accessible by each of the bidders and/or by each of the receivers, such as via the respective computing devices 104, 106 utilized, thereby. Once a bid is received from a bidder (e.g., F Corp) that is greater than or equal to a reserve price set by a receiver corresponding to the item 714, if any, the matching module 228 of the computing device 102 may match the item 714 and F Corp. Alternatively, in a decentralized auction the matching module 528 operable on the computing devices 106(1), 104(2) may perform such a matching function.

Additionally, at this stage of the auction the matching module 228 of the computing device 102 may remove the item 714 and Brianna from the auction 728. Additionally, and/or, alternatively, the matching module 228 may remove F Corp from the auction 728. Further, it is understood that in a decentralized auction the matching module 528 operable on the computing devices 106(1), 104(2) may remove the item 714, F Corp, and Brianna from the auction 728. FIG. 7D illustrates a further part of the example one-sided auction 728 in which the item 714, F Corp, and Brianna have been removed.

As shown in FIG. 7D, Adam, Carlos, D Corp, and E Corp may remain in the auction 728 until future matches are made in accordance with the methods described herein. For example, the active counter value may continue to decrease until an additional bid is received by one of the remaining bidders. FIG. 7D illustrates an example bid of $220,000 entered by E Corp for an item 732 provided by Adam. If the bid of $220,000 is equal to or greater than any reserve price set by Adam prior to the auction 728, E Corp will be matched with the item 732. The auction 728 will continue in this fashion until either all bidders have been matched, all items have been matched, or an alternative stopping condition is reached such as the counter value reaching a predetermined threshold value. Additionally, as part of any of the methods described herein, once a match has been made one or more of the computing devices may determine an amount required for the bidder to pay to the receiver for the item, or vice versa. Additionally, such methods may include providing a payment request to the bidder and/or the receiver.

### EXAMPLE CLAUSES

A: A system comprising: one or more processing units; and computer-readable media operably connected to the one or more processing units, the computer-readable media storing a plurality of modules that, when executed by the one or more processing units, cause the one or more processing units to perform operations comprising: receiving, by a communication module, first information from a computing device of a bidder, and receiving second information from a computing device of a receiver, the first information describing the bidder and the second information describing an item provided for auction by the receiver; encrypting, by an encryption module, the first information and the second information received by the communication module, thereby generating encrypted information with the encryption module; generating, by a counter module, a series of decreasing counter values during an auction of the item; transferring, by the communication module, at least a portion of the encrypted information to at least one of the computing device of the bidder and the computing device of the receiver; and matching, by a matching module, the bidder and the item at least partly in response to a bid received by the communication module from the computing device of the bidder during the auction, wherein: the bid comprises a first amount proposed by the bidder for matching the bidder and the item, the matching module matches the bidder and the item based at least partly on a particular counter value of the series of counter values active when the bid is received, and the matching module removes the bidder and the item from the auction based at least partly on the matching.

B: The system of clause A, wherein, when executed, the matching module performs further operations, comprising: automatically setting the first amount of the bid equal to the particular counter value, and matching the bidder and the item without receiving an ask from the receiver corresponding to the bid.

C: The system of clause A or B, wherein, when executed, the communication module performs further operations, comprising: providing each value of the series of counter values to the computing device of the bidder.

D: The system of clause A, B, or C, wherein, when executed, the communication module performs further operations, comprising: receiving, from the computing device of the bidder and during the auction, an information request associated with the item, and providing information associated with the item to the computing device of the bidder prior to receiving the bid, at least partly in response to receiving the information request.

E: The system of clause A, B, C, or D, wherein, when executed, the communication module performs further operations, comprising: receiving the first information from the computing device of the bidder via a network, and receiving the second information from the computing device of the receiver via the network.

F: The system of clause A, B, C, D, or E, wherein, when executed, the communication module performs further operations, comprising: receiving an ask from the computing device of the receiver, wherein the ask comprises a second amount proposed by the receiver for matching the item and the bidder.

G: The system of clause F, wherein, when executed, the matching module performs further operations, comprising: determining a difference between the first and second amounts, and wherein the bidder and the item are matched at least partly in response to the difference being greater than or equal to the particular counter value.

H: The system of clause F or G, the operations further comprising, at least partly in response to the matching: determining, by a payment module, an average of the first amount and the second amount, generating, by the payment module, a payment request comprising a third amount equal to the average, and providing, by the communication module, the payment request to the computing device of the bidder.

I: A method, comprising: receiving a bid for an item from a computing device of a bidder of a plurality of bidders, wherein: the bid is received, via a network to which the computing device of the bidder is connected, during an auction associated with the item, the auction is governed by a series of decreasing counter values generated during the auction, and the series of decreasing counter values comprises a particular counter value that is active when the bid is received; receiving an information request associated with the item from a computing device of at least one bidder of the plurality of bidders during the auction; and matching the item and the bidder at least partly in response to receiving the bid, wherein the bidder and the item are removed from the auction based at least partly on the matching.

J: The method of clause I, further including providing information associated with the item to the computing device of the at least one of the bidders, prior to receiving the bid, at least partly in response to receiving the information request.

K: The method of clause I or J, wherein the matching is performed by one of the computing device of the bidder, a computing device of a receiver associated with the item, and a computing device in communication with the computing device of the bidder and the computing device of the receiver via the network.

L: The method of clause I, J, or K, wherein the item comprises one of a plurality of items available in the auction, each item of the plurality of items being provided by a respective receiver of a plurality of receivers, the method further comprising: providing information associated with one or more items of the plurality of items to the computing device of the bidder during the auction and prior to receiving the bid, and receiving a modification to the bid from the computing device of the bidder based at least partly on the information.

M: The method of clause I, J, K, or L, further comprising receiving a search query from the computing device of the at least one bidder of the plurality of bidders, the search query comprising a request for information regarding at least one of: a plurality of items available in the auction, and a plurality of receivers participating in the auction.

N: The method of clause I, J, K, L, or M, wherein the bid comprises an encryption key, the method further including authenticating the encryption key and verifying an identity of the bidder based at least partly on the authenticating.

O: A method, comprising: receiving a bid for an item from a computing device of a bidder, wherein: the bid is received, via a network to which the computing device of the bidder is connected, during an auction associated with the item, the item is provided for the auction by a receiver, and the bid comprises a first amount proposed by the bidder for matching the bidder and the item; receiving an ask from a computing device of the receiver, wherein the ask comprises a second amount proposed by the receiver for matching the item and the bidder; determining a difference between the first and second amounts; generating a series of decreasing counter values; and matching the bidder and the item at least partly in response to the difference being greater than or equal to a particular counter value of the series of counter values that is currently active, wherein the bidder and the item are removed from the auction based at least partly on the matching.

P: The method of clause O, wherein a plurality of bidders and a plurality of receivers are participating in the auction, and the series of decreasing counter values is accessible by each bidder of the plurality of bidders and each receiver of the plurality of receivers during the auction.

Q: The method of clause O or P, further comprising: receiving an information request associated with the item, from the computing device of the bidder during the auction, and providing information associated with the item to the computing device of the bidder prior to receiving the bid and at least partly in response to receiving the information request.

R: The method of clause O, P, or Q, further comprising, at least partly in response to the matching: determining an average of the first amount and the second amount, generating a payment request comprising a third amount equal to the average, and providing the payment request to the computing device of the bidder via the network.

S: The method of clause O, P, Q, or R, further comprising receiving at least one of: a) a modification to the bid from the computing device of the bidder, and b) a modification to the ask from the computing device of the receiver, wherein the at least one of the modification to the bid and the modification to the ask is received by an auction service computing device, and wherein the auction service computing device is in communication with the computing device of the bidder and the computing device of the receiver via the network.

T: The method of clause O, P, Q, R, or S, further comprising generating encrypted information by encrypting information received from at least one of the computing device of the bidder and the computing device of the receiver, and storing the encrypted information within computer-readable media of an auction service computing device, wherein the auction service computing device is in communication with the computing device of the bidder and the computing device of the receiver via the network.

### Conclusion

Various systems, environments, and/or methods described herein can permit efficient matching of bidders and receivers in one-sided and two-sided auctions. Due at least in part to each of the example auctions described herein being governed in accordance with a series of descending counter values, such auctions result in relatively high-value matches between bidders and items/receivers taking place before the relatively low-value matches between such bidders and items/receivers. As a result, example auctions of the present disclosure reduce the amount of time, effort, and other resources that bidders and/or receivers must invest in determining the quality of potential matches, resulting in more economically efficient outcomes than conventional auctions. Additionally, due to the techniques described herein, information associated with such auctions may be transmitted across one or more networks in a more efficient and secure manner, and in a manner that reduces the bandwidth, memory, and/or other resource requirements of the systems described herein. As a result, the methods described herein improve the functionality of such systems.

Although the techniques have been described in language specific to structural features or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more computing device(s) 102, 104, or 200 such as one or more internal or external CPUs or GPUs, and/or one or more pieces of hardware logic such as FPGAs, DSPs, or other types described above.

Conditional language such as, among others, “can,” “could,” “might” or “may,” unless specifically stated otherwise, mean that certain examples include, while other examples do not include, certain features, elements and/or operations. Thus, such conditional language is meant to indicate that certain features, elements and/or operations are permissible but not required for one or more examples. Conjunctive language such as the phrase “at least one of X, Y or Z” and “and/or,” unless specifically stated otherwise, is to be understood to present that an item, term, etc., can be either X, Y, or Z, or a combination thereof.

Any descriptions, elements or blocks in the flow diagrams described herein and/or depicted in the attached figures should be understood as representing modules, segments, or portions of code that include one or more executable instructions for implementing specific logical functions or elements. Many variations and modifications can be made to the above-described examples. All such modifications and variations are intended to be included herein within the scope of this disclosure and protected by the following claims. For instance, the examples described herein include variations in which elements or functions are deleted, or executed out of order from that shown or discussed, including substantially synchronously or in reverse order, depending on the functionality involved as would be understood by those skilled in the art.

What is claimed is:

1. A system comprising:
one or more processing units; and
computer-readable media operably connected to the one or more processing units, the computer-readable media storing a plurality of modules that, when executed by the one or more processing units, cause the one or more processing units to perform operations comprising:
receiving, by a communication module, first information from a computing device of a bidder, and receiving second information from a computing device of a receiver, the first information describing the bidder and the second information describing an item provided for auction by the receiver;
encrypting, by an encryption module, the first information and the second information received by the communication module, thereby generating encrypted information with the encryption module;
generating, by a counter module, a series of decreasing counter values during an auction of the item;
transferring, by the communication module, at least a portion of the encrypted information to at least one of the computing device of the bidder and the computing device of the receiver; and
matching, by a matching module, the bidder and the item at least partly in response to a bid received by the communication module from the computing device of the bidder during the auction, wherein:
the bid comprises a first amount proposed by the bidder for matching the bidder and the item,
the matching module matches the bidder and the item based at least partly on a particular counter value of the series of counter values active when the bid is received, and
the matching module removes the bidder and the item from the auction based at least partly on the matching.

2. The system of claim 1, wherein, when executed, the matching module performs further operations, comprising:
automatically setting the first amount of the bid equal to the particular counter value, and
matching the bidder and the item without receiving an ask from the receiver corresponding to the bid.

3. The system of claim 1, wherein, when executed, the communication module performs further operations, comprising: providing each value of the series of counter values to the computing device of the bidder.

4. The system of claim 1, wherein, when executed, the communication module performs further operations, comprising:
receiving, from the computing device of the bidder and during the auction, an information request associated with the item, and
providing information associated with the item to the computing device of the bidder prior to receiving the bid, at least partly in response to receiving the information request.

5. The system of claim 1, wherein, when executed, the communication module performs further operations, comprising: receiving the first information from the computing device of the bidder via a network, and receiving the second information from the computing device of the receiver via the network.

6. The system of claim 1, wherein, when executed, the communication module performs further operations, comprising: receiving an ask from the computing device of the receiver, wherein the ask comprises a second amount proposed by the receiver for matching the item and the bidder.

7. The system of claim 6, wherein, when executed, the matching module performs further operations, comprising: determining a difference between the first and second amounts, and wherein the bidder and the item are matched at least partly in response to the difference being greater than or equal to the particular counter value.

8. The system of claim 6, the operations further comprising, at least partly in response to the matching:
determining, by a payment module, an average of the first amount and the second amount,
generating, by the payment module, a payment request comprising a third amount equal to the average, and
providing, by the communication module, the payment request to the computing device of the bidder.

9. A method, comprising:
receiving a bid for an item from a computing device of a bidder of a plurality of bidders, wherein:
the bid is received, via a network to which the computing device of the bidder is connected, during an auction associated with the item,
the auction is governed by a series of decreasing counter values generated during the auction, and
the series of decreasing counter values comprises a particular counter value that is active when the bid is received;
receiving an information request associated with the item from a computing device of at least one bidder of the plurality of bidders during the auction; and
matching the item and the bidder at least partly in response to receiving the bid, wherein the bidder and the item are removed from the auction based at least partly on the matching.

10. The method of claim 9, further including providing information associated with the item to the computing device of the at least one of the bidders, prior to receiving the bid, at least partly in response to receiving the information request.

11. The method of claim 9, wherein the matching is performed by one of the computing device of the bidder, a computing device of a receiver associated with the item, and a computing device in communication with the computing device of the bidder and the computing device of the receiver via the network.

12. The method of claim 9, wherein the item comprises one of a plurality of items available in the auction, each item of the plurality of items being provided by a respective receiver of a plurality of receivers, the method further comprising:
providing information associated with one or more items of the plurality of items to the computing device of the bidder during the auction and prior to receiving the bid, and
receiving a modification to the bid from the computing device of the bidder based at least partly on the information.

13. The method of claim 9, further comprising receiving a search query from the computing device of the at least one bidder of the plurality of bidders, the search query comprising a request for information regarding at least one of:
a plurality of items available in the auction, and
a plurality of receivers participating in the auction.

14. The method of claim 9, wherein the bid comprises an encryption key, the method further including authenticating the encryption key and verifying an identity of the bidder based at least partly on the authenticating.

15. A method, comprising:
receiving a bid for an item from a computing device of a bidder, wherein:
the bid is received, via a network to which the computing device of the bidder is connected, during an auction associated with the item,
the item is provided for the auction by a receiver,
and the bid comprises a first amount proposed by the bidder for matching the bidder and the item;
receiving an ask from a computing device of the receiver, wherein the ask comprises a second amount proposed by the receiver for matching the item and the bidder;
determining a difference between the first and second amounts;
generating a series of decreasing counter values; and
matching the bidder and the item at least partly in response to the difference being greater than or equal to a particular counter value of the series of counter values that is currently active, wherein
the bidder and the item are removed from the auction based at least partly on the matching.

16. The method of claim 15, wherein a plurality of bidders and a plurality of receivers are participating in the auction, and the series of decreasing counter values is accessible by each bidder of the plurality of bidders and each receiver of the plurality of receivers during the auction.

17. The method of claim 15, further comprising:
receiving an information request associated with the item, from the computing device of the bidder during the auction, and
providing information associated with the item to the computing device of the bidder prior to receiving the bid and at least partly in response to receiving the information request.

18. The method of claim 15, further comprising, at least partly in response to the matching:
determining an average of the first amount and the second amount,
generating a payment request comprising a third amount equal to the average, and
providing the payment request to the computing device of the bidder via the network.

19. The method of claim 15, further comprising receiving at least one of:
a) a modification to the bid from the computing device of the bidder, and
b) a modification to the ask from the computing device of the receiver, wherein the at least one of the modification to the bid and the modification to the ask is received by an auction service computing device, and wherein the auction service computing device is in communication with the computing device of the bidder and the computing device of the receiver via the network.

20. The method of claim 15, further comprising generating encrypted information by encrypting information received from at least one of the computing device of the bidder and the computing device of the receiver, and storing the encrypted information within computer-readable media of an auction service computing device, wherein the auction service computing device is in communication with the computing device of the bidder and the computing device of the receiver via the network.
